(19) United States
(12) Patent Application Publication
(10) Pub. No.: US 2026/0101225 A1
(43) Pub. Date: Apr. 9, 2026

(54) COMMUNICATION METHOD AND RELAY APPARATUS

(71) Applicant: KYOCERA Corporation, Kyoto (JP)

(72) Inventor: Masato FUJISHIRO, Yokohama-shi (JP)

(73) Assignee: KYOCERA Corporation, Kyoto (JP)

(21) Appl. No.: 19/414,654

(22) Filed: Dec. 10, 2025

Related U.S. Application Data
(63) Continuation of application No. PCT/JP2024/021076, filed on Jun. 10, 2024.

(30) Foreign Application Priority Data
Jun. 12, 2023 (JP) 2023-096093

(51) Int. Cl. H04W 24/10; H04W 4/02; H04W 76/27

(52) U.S. Cl. CPC H04W 24/10; H04W 4/025; H04W 76/27

(57) ABSTRACT

A communication method performed in a relay apparatus, the relay apparatus including a relay device configured to perform a relay operation of relaying a radio signal transmitted between a network and a user equipment, and a control terminal configured to receive a control signal used for control of the relay device from the network, the method including the steps of measuring a radio environment related to the relay apparatus, and transmitting measurement information obtained by the measuring from the control terminal to the network.

### RELATED APPLICATIONS

The present application is a continuation based on PCT Application No. PCT/JP2024/021076, filed on Jun. 10, 2024, which claims the benefit of Japanese Patent Application No. 2023-096093 filed on Jun. 12, 2023. The content of which is incorporated by reference herein in their entirety.

### TECHNICAL FIELD

The present disclosure relates to a communication method and a relay apparatus used in a mobile communication system.

### BACKGROUND

In recent years, a mobile communication system of the fifth generation (5G) has been attracting attention. New Radio (NR), which is a radio access technology of the 5G system, is capable of wide-band transmission via a high frequency band as opposed to Long Term Evolution (LTE), which is a fourth-generation radio access technology.

Since radio signals (radio waves) in the high frequency band such as a millimeter wave band or a terahertz wave band have high rectilinearity, reduction of coverage of a base station is a problem. In order to solve such a problem, a repeater apparatus that is a type of relay apparatus relaying radio signals between the network and a user equipment and can be controlled from a network is attracting attention (see, for example, Non-Patent Document 1).

Such a repeater apparatus can extend the coverage of the base station while suppressing occurrence of interference by, for example, amplifying a radio signal received from the base station and transmitting the radio signal through directional transmission. Such a repeater apparatus is also referred to as a network-controlled repeater (NCR) apparatus.

### CITATION LIST

### Non-Patent Literature

Non-Patent Literature 1: 3GPP Contribution: RP-213700, “New SI: Study on NR Network-controlled Repeaters”

### SUMMARY

A communication method according to a first aspect is a communication method performed in a relay apparatus, the relay apparatus including a relay device configured to perform a relay operation of relaying a radio signal transmitted between a network and a user equipment, and a control terminal configured to receive a control signal used for control of the relay device from the network, the method including the steps of measuring a radio environment related to the relay apparatus, and transmitting measurement information obtained by the measuring from the control terminal to the network.

A relay apparatus according to a second aspect is a relay apparatus including a relay device configured to perform a relay operation of relaying a radio signal transmitted between a network and a user equipment, and a control terminal configured to receive a control signal used for control of the relay device from the network, wherein the control terminal is configured to measure a radio environment related to the relay apparatus, and transmit measurement information obtained by the measuring from the control terminal to the network.

### BRIEF DESCRIPTION OF THE DRAWINGS

FIG. 1 is a diagram illustrating a configuration of a mobile communication system according to an embodiment.

FIG. 2 is a diagram illustrating a configuration of a protocol stack of a wireless interface of a user plane handling data.

FIG. 3 is a diagram illustrating a configuration of a protocol stack of a wireless interface of a control plane handling signaling (control signal).

FIG. 4 is a diagram illustrating an example of an application scenario of an NCR apparatus (relay apparatus) according to a first embodiment.

FIG. 5 is a diagram illustrating an example of an application scenario of the NCR apparatus according to the first embodiment.

FIG. 6 is a diagram illustrating an example of a control method for the NCR apparatus according to the first embodiment.

FIG. 7 is a diagram illustrating an example of a configuration of a protocol stack in the NCR apparatus according to the first embodiment.

FIG. 8 is a diagram illustrating an example of an operation of a mobile communication system according to the first embodiment.

FIG. 9 is a diagram illustrating a configuration example of the NCR apparatus according to the first embodiment.

FIG. 10 is a diagram illustrating a configuration of a user equipment (UE) according to the embodiment.

FIG. 11 is a diagram illustrating an example of a configuration of a gNB (base station) according to the embodiment.

FIG. 12 is a flowchart illustrating an operation of the NCR apparatus according to the first embodiment.

FIG. 13 is a diagram illustrating a first operation pattern according to the first embodiment.

FIG. 14 is a diagram illustrating a second operation pattern according to the first embodiment.

FIG. 15 is a diagram illustrating an operation scenario for a third operation pattern according to the first embodiment.

FIG. 16 is a diagram illustrating the third operation pattern according to the first embodiment.

FIG. 17 is a diagram illustrating an example of an application scenario of a RIS apparatus (relay apparatus) according to a second embodiment.

FIG. 18 is a diagram illustrating an example of a configuration of the RIS apparatus according to the second embodiment.

### DESCRIPTION OF EMBODIMENTS

Network optimization may be achieved and an introduction effect of a relay apparatus as described above may be enhanced by a network autonomously adjusting configuration parameters for the relay apparatus or by the network autonomously changing an operation of the relay apparatus.

Therefore, the present disclosure facilitates realization of the network optimization.

A mobile communication system according to an embodiment is described with reference to the drawings. In the description of the drawings, the same or similar parts are denoted by the same or similar reference signs.

### (1) First Embodiment

A first embodiment is described first. In the first embodiment, a relay apparatus is a repeater apparatus (that is, an NCR apparatus) that can be controlled from a network.

### (1.1) Overview of Mobile Communication System

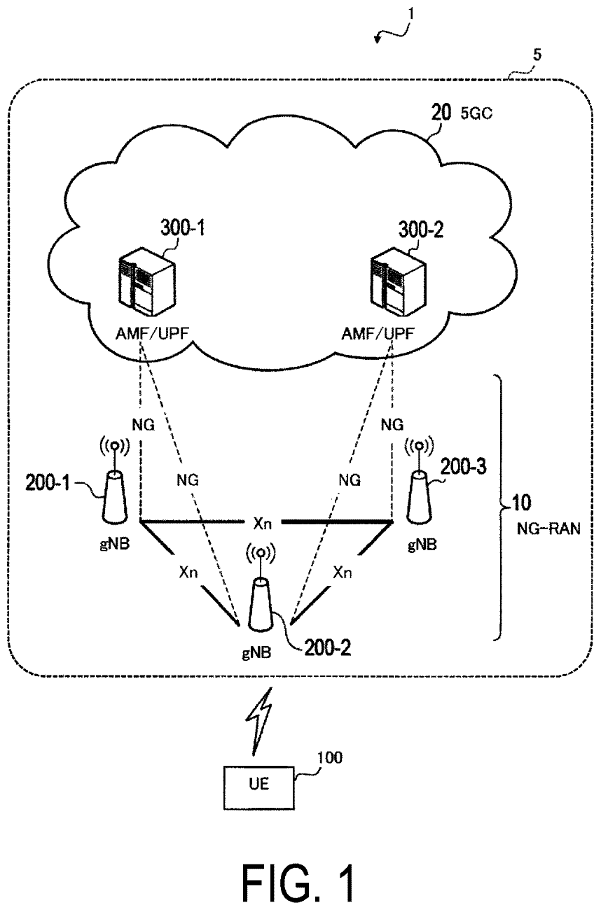

FIG. 1 is a diagram illustrating a configuration of a mobile communication system according to the first embodiment.

A mobile communication system 1 complies with the 5th Generation System (5GS) of the 3rd Generation Partnership Project (3GPP; trade name, the same applies below) standard. The description below takes the 5GS as an example, but Long Term Evolution (LTE) system may be at least partially applied to the mobile communication system. Alternatively, a sixth generation (6G) system may be at least partially applied to the mobile communication system.

The mobile communication system 1 includes User Equipment (UE) 100, a 5G radio access network (Next Generation Radio Access Network (NG-RAN)) 10, and a 5G Core Network (5GC) 20. Hereinafter, the NG-RAN 10 may be simply referred to as a RAN 10. The 5GC 20 may be simply referred to as a core network (CN) 20. The RAN 10 and the CN 20 constitute a network 5 of the mobile communication system 1.

The UE 100 is a mobile wireless communication apparatus. The UE 100 may be any apparatus as long as the UE 100 is used by a user. Examples of the UE 100 include a mobile phone terminal (including a smartphone) and/or a tablet terminal, a notebook PC, a communication module (including a communication card or a chipset), a sensor or an apparatus provided on a sensor, a vehicle or an apparatus provided on a vehicle (Vehicle UE), and a flying object or an apparatus provided on a flying object (Aerial UE).

The NG-RAN 10 includes base stations (referred to as “gNBs” in the 5G system) 200. The gNBs 200 are interconnected via an Xn interface which is an inter-base station interface. Each gNB 200 manages one or more cells. The gNB 200 performs wireless communication with the UE 100 that has established a connection to the cell of the gNB 200. The gNB 200 has a radio resource management (RRM) function, a function of routing user data (hereinafter simply referred to as “data”), a measurement control function for mobility control and scheduling, and the like. The “cell” is used as a term representing a minimum unit of a wireless communication area. The “cell” is also used as a term representing a function or a resource for performing wireless communication with the UE 100. One cell belongs to one carrier frequency (hereinafter, simply referred to as a “frequency”).

The gNB 200 may be functionally divided into a central unit (CU) and a distributed unit (DU). The CU controls the DU. The CU is a unit including upper layers included in a protocol stack described below, such as an RRC layer, an SDAP layer, and a PDCP layer, for example. The CU is connected to a core network via an NG interface which is a backhaul interface. The CU is connected to an adjacent base station via the Xn interface, which is an inter-base station interface. The DU forms a cell. The DU 202 is a unit including lower layers included in the protocol stack described below, such as an RLC layer, a MAC layer, and a PHY layer, for example. The DU is connected to the CU via an F1 interface which is a fronthaul interface.

Note that the gNB can be connected to an Evolved Packet Core (EPC) corresponding to a core network of LTE. An LTE base station can also be connected to the 5GC. The LTE base station and the gNB can be connected via an inter-base station interface.

The 5GC 20 includes an Access and Mobility Management Function (AMF) and a User Plane Function (UPF) 300. The AMF performs various types of mobility controls and the like for the UE 100. The AMF manages mobility of the UE 100 by communicating with the UE 100 by using Non-Access Stratum (NAS) signaling. The UPF controls data transfer. The AMF and UPF are connected to the gNB 200 via an NG interface which is an interface between a base station and the core network.

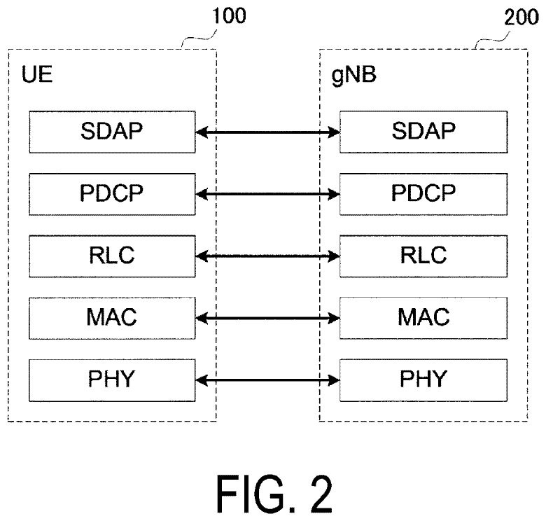

FIG. 2 is a diagram illustrating a configuration of a protocol stack of a wireless interface of a user plane handling data.

A wireless interface protocol of the user plane includes a PHYsical (PHY) layer, a Medium Access Control (MAC) layer, a Radio Link Control (RLC) layer, a Packet Data Convergence Protocol (PDCP) layer, and a Service Data Adaptation Protocol (SDAP) layer.

The PHY layer performs coding and decoding, modulation and demodulation, antenna mapping and demapping, and resource mapping and demapping. Data and control information are transmitted between the PHY layer of the UE 100 and the PHY layer of the gNB 200 via a physical channel. Note that the PHY layer of the UE 100 receives downlink control information (DCI) transmitted from the gNB 200 over a physical downlink control channel (PDCCH). Specifically, the UE 100 performs blind decoding of PDCCH using a radio network temporary identifier (RNTI) and acquires successfully decoded DCI as DCI addressed to the UE. A CRC bit scrambled by the RNTI is added to the DCI transmitted from the gNB 200.

The gNB 200 transmits a synchronization signal block (SSB: Synchronization Signal/PBCH block). For example, the SSB includes four consecutive Orthogonal Frequency Division Multiplex (OFDM) symbols, and a primary synchronization signal (PSS), a secondary synchronization signal (SSS), a physical broadcast channel (PBCH)/master information block (MIB), and a demodulation reference signal (DMRS) of the PBCH are disposed. A bandwidth of the SSB is, for example, a bandwidth of 240 consecutive subcarriers, that is, 20 RB.

The MAC layer performs priority control of data, retransmission processing through hybrid ARQ (Hybrid Automatic Repeat reQuest (HARQ)), a random access procedure, and the like. Data and control information are transmitted between the MAC layer of the UE 100 and the MAC layer of the gNB 200 via a transport channel. The MAC layer of the gNB 200 includes a scheduler. The scheduler decides transport formats (transport block sizes, Modulation and Coding Schemes (MCSs)) in the uplink and the downlink and resource blocks to be allocated to the UE 100.

The RLC layer transmits data to the RLC layer on the reception end by using functions of the MAC layer and the PHY layer. Data and control information are transmitted between the RLC layer of the UE 100 and the RLC layer of the gNB 200 via a logical channel.

The PDCP layer performs header compression and decompression, encryption and decryption, and the like.

The SDAP layer performs mapping between an IP flow as the unit of Quality of Service (QoS) control performed by a core network and a radio bearer as the unit of QoS control performed by an Access Stratum (AS). Note that, when the RAN is connected to the EPC, the SDAP need not be provided.

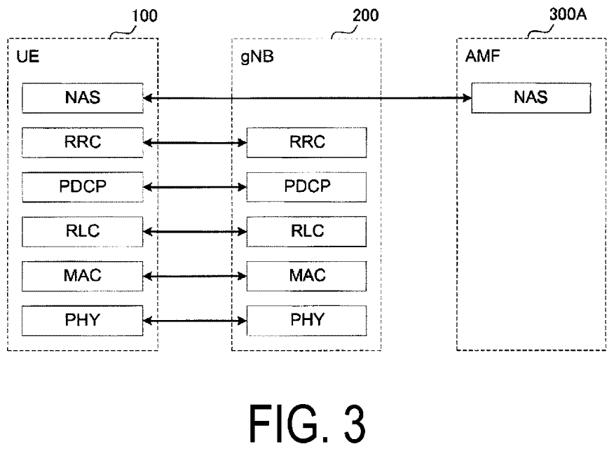

FIG. 3 is a diagram illustrating a configuration of a protocol stack of a wireless interface of a control plane handling signaling (a control signal).

The protocol stack of the wireless interface of the control plane includes a Radio Resource Control (RRC) layer and a Non-Access Stratum (NAS) layer instead of the SDAP layer illustrated in FIG. 2.

RRC signaling for various configurations is transmitted between the RRC layer of the UE 100 and the RRC layer of the gNB 200. The RRC layer controls a logical channel, a transport channel, and a physical channel according to establishment, re-establishment, and release of a radio bearer. When a connection (RRC connection) between the RRC of the UE 100 and the RRC of the gNB 200 is present, the UE 100 is in an RRC connected state. When no connection (RRC connection) between the RRC of the UE 100 and the RRC of the gNB 200 is present, the UE 100 is in an RRC idle state. When the connection between the RRC of the UE 100 and the RRC of the gNB 200 is suspended, the UE 100 is in an RRC inactive state.

The NAS layer, which is located above the RRC layer, performs session management, mobility management, and the like. NAS signaling is transmitted between the NAS layer of the UE 100 and the NAS layer of an AMF 300A. Note that the UE 100 includes an application layer other than the protocol of the wireless interface. A layer lower than the NAS layer is referred to as an Access Stratum (AS).

### (1.2) Example of Application Scenario of Relay Apparatus

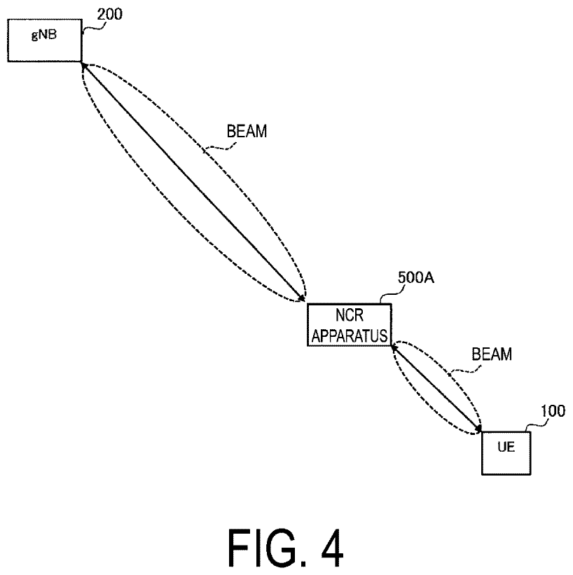

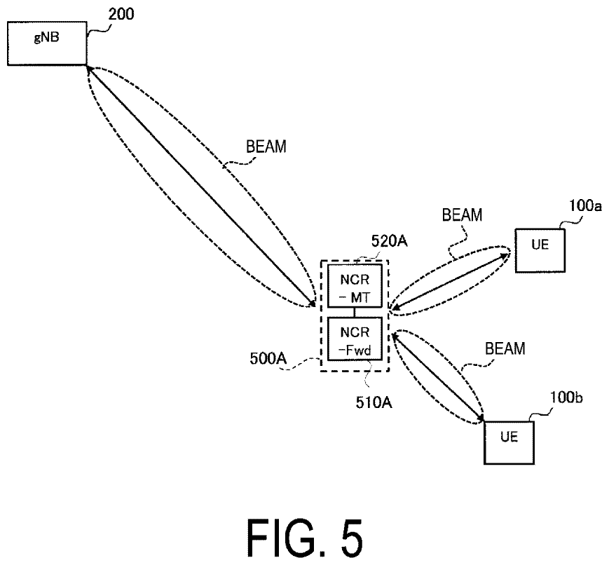

FIGS. 4 and 5 are diagrams illustrating an example of an application scenario of the NCR apparatus according to the first embodiment.

The 5G/NR is capable of wide-band transmission via a high frequency band compared to the 4G/LTE. Since radio signals in the high frequency band such as a millimeter wave band or a terahertz wave band have high rectilinearity, a problem is reduction of coverage of the gNB 200. In FIG. 4, the UE 100 may be located outside a coverage area of the gNB 200, for example, outside an area where the UE 100 can receive radio signals directly from the gNB 200. The UE 100 may be in a state of not communicatable with the gNB 200 within a line of sight because of obstacles existing between the gNB 200 and the UE 100.

As illustrated in FIG. 4, an NCR apparatus 500A is introduced into the mobile communication system 1, wherein the NCR apparatus 500A is a repeater apparatus (500A) as a type of relay apparatus relaying radio signals between the gNB 200 and the UE 100, and can be controlled from the network 5. Such a repeater apparatus may be called a smart repeater apparatus.

For example, the NCR apparatus 500A amplifies a radio signal (radio wave) received from the gNB 200 and transmits the radio signal through directional transmission. To be specific, the NCR apparatus 500A receives a radio signal transmitted by the gNB 200 through beamforming. The NCR apparatus 500A amplifies the received radio signal without demodulation and modulation and transmits the amplified radio signal through the directional transmission. Here, the NCR apparatus 500A may transmit the radio signal with a fixed directivity (beam). The NCR apparatus 500A may transmit a radio signal with a variable (adaptive) directional beam. This can efficiently extend the coverage of the gNB 200.

As illustrated in FIG. 5, a new UE (hereinafter referred to as “NCR-MT (Mobile termination)”) 100B, which is a type of control terminal for controlling the NCR apparatus 500A, is introduced. That is, the NCR apparatus 500A includes an NCR-Fwd (Forward) 510A, which is a type of a relay device that relays a radio signal transmitted between the gNB 200 and the UE 100, specifically, changes a propagation state of the radio signal without demodulating or modulating the radio signal, and an NCR-MT 520A that performs wireless communication with the gNB 200 to control the NCR-Fwd 510A.

Thus, the NCR-MT 520A controls the NCR apparatus 500A in cooperation with the gNB 200 by establishing a wireless connection to the gNB 200 and performing wireless communication to the gNB 200. Accordingly, efficient coverage extension can be realized using the NCR apparatus 500A. The NCR-MT 520A controls the NCR apparatus 500A according to control from the gNB 200. The NCR-MT 520A also has the same and/or similar function as that of the UE 100.

The NCR-MT 520A may be configured separately from the NCR-Fwd 510A. For example, the NCR-MT 520A may be located near the NCR-Fwd 510A and may be electrically connected to the NCR-Fwd 510A. The NCR-MT 520A may be connected to the NCR-Fwd 510A by wire or wireless. The NCR-MT 520A may be configured integrally with the NCR-Fwd 510A. The NCR-MT 520A and the NCR-Fwd 510A may be fixedly installed at a coverage edge (cell edge) of the gNB 200, or on a wall surface or window of any building, for example. The NCR-MT 520A and the NCR-Fwd 510A may be installed, for example, in a vehicle or the like and may be mobile. One NCR-MT 520A may control the plurality of NCR-Fwds 510A.

The configuration is not limited to a configuration in which the NCR-MT 520A directly controls one or more NCR-Fwds 510A, and may be configuration in which the NCR-MT 520A indirectly controls one or more NCR-Fwds 510A. For example, the NCR-MT 520A may control one or more NCR-Fwds 510A via an upper layer (for example, an application layer).

In the example illustrated in FIG. 5, the NCR apparatus 500A (NCR-Fwd 510A) dynamically or quasi-statically changes a beam to be transmitted or received. For example, the NCR-Fwd 510A forms a beam toward each of a UE 100a and a UE 100b. The NCR-Fwd 510A may also form a beam toward the gNB 200. For example, in a communication resource between the gNB 200 and the UE 100a, the NCR-Fwd 510A transmits a radio signal received from the gNB 200 toward the UE 100a through beamforming and/or transmits a radio signal received from the UE 100a toward the gNB 200 through beamforming. In a communication resource between the gNB 200 and the UE 100b, the NCR-Fwd 510A transmits the radio signal received from the gNB 200 toward the UE 100b through beamforming and/or transmits the radio signal received from the UE 100b toward the gNB 200 through beamforming. Instead of or in addition to the beamforming, the NCR-Fwd 510A may perform null forming (so-called null steering) toward the UE 100 which is not a communication partner (not illustrated) and/or a neighboring gNB 200 (not illustrated) to curb interference.

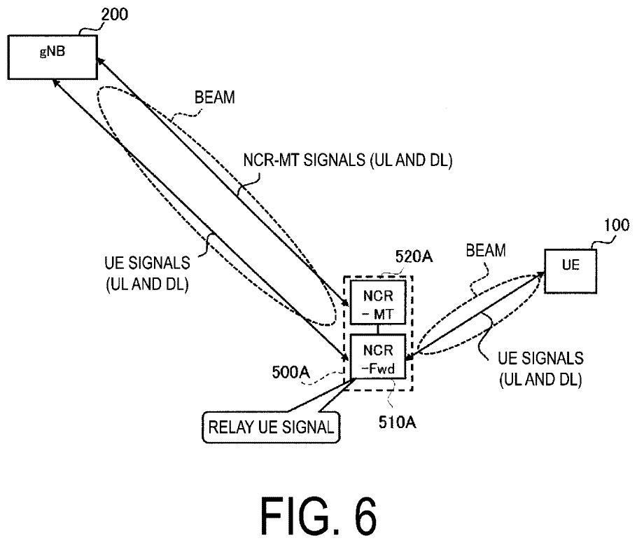

FIG. 6 is a diagram illustrating an example of a control method for the NCR apparatus 500A according to the first embodiment.

The NCR-Fwd 510A relays radio signals (also referred to as “UE signals”) between the gNB 200 and the UE 100. The UE signal includes an uplink signal transmitted from the UE 100 to the gNB 200 (also referred to as “UE-UL signal”) and a downlink signal transmitted from the gNB 200 to the UE 100 (also referred to as “UE-DL signal”). The NCR-Fwd 510A relays the UE-UL signal from the UE 100 to the gNB 200 and relays the UE-DL signal from the gNB 200 to the UE 100. A radio link between the NCR-Fwd 510A and the UE 100 is also referred to as an “access link”. A radio link between the NCR-Fwd 510A and the gNB 200 is also referred to as a “backhaul link”.

The NCR-MT 520A transmits and/or receives a radio signal (herein referred to as an “NCR-MT signal”) to and from the gNB 200. The NCR-MT signal includes an uplink signal transmitted from the NCR-MT 520A to the gNB 200 (referred to as an “NCR-MT-UL signal”), and a downlink signal transmitted from the gNB 200 to the NCR-MT 520A (referred to as an “NCR-MT-DL signal”). The NCR-MT-DL signal includes signaling for controlling the NCR apparatus 500A (for example, an NCR control signal). A wireless link between the NCR-MT 520A and the gNB 200 is also referred to as a “control link.”

The gNB 200 directs a beam to the NCR-MT 520A based on the NCR-MT-UL signal from the NCR-MT 520A. Since the NCR apparatus 500A and the NCR-MT 520A are co-located, the beam is also eventually directed to the NCR-Fwd 510A when the backhaul link and the control link have the same frequency and the gNB 200 directs a beam to the NCR-MT 520A. The gNB 200 transmits the NCR-MT-DL signal and the UE-DL signal using the beam. The NCR-MT 520A receives the NCR-MT-DL signal. When the NCR-Fwd 510A and the NCR-MT 520A are at least partially integrated, a function (for example, antennas) for transmitting and/or receiving, or relaying UE signals and/or NCR-MT signals may be integrated in the NCR-Fwd 510A and the NCR-MT 520A. The beam includes a transmission beam and/or a reception beam. The beam is a general term for transmission and/or reception under control for maximizing power of a transmission wave and/or a reception wave in a specific direction by adjusting/adapting an antenna weight or the like.

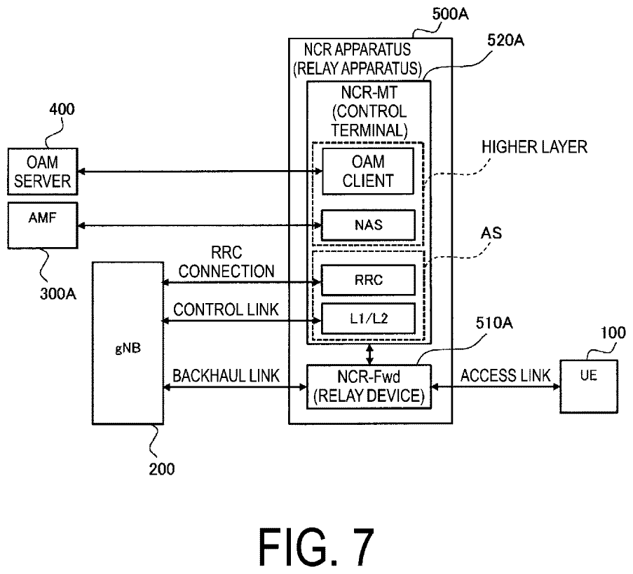

FIG. 7 is a diagram illustrating an example of a configuration of a protocol stack in the NCR apparatus 500A according to the first embodiment.

The NCR-Fwd 510A relays a radio signal transmitted and/or received between the gNB 200 and the UE 100. The NCR-Fwd 510A has a Radio Frequency (RF) function of amplifying and relaying a received radio signal, and performs directional transmission through beamforming (for example, analog beamforming).

The NCR-MT 520A includes entities of the layer 1 and/or the layer 2 (L1/L2), and each layer of the RRC and the NAS. The L1/L2 (in particular, PHY, MAC) and the RRC of the NCR-MT 520A are also referred to as “AS of the NCR-MT 520A ”.

The NCR-MT 520A may include at least one selected from the group consisting of an operation, administration, maintenance (OAM) client communicating with an OAM server 400, a NAS layer communicating with the AMF 300A, and an F1 application protocol (AP) layer. The OAM client, the NAS layer, and the F1-AP layer of the NCR-MT 520A are also referred to as “upper layers of the NCR-MT 520A” with reference to the AS of the NCR-MT 520A.

A backhaul link is established between the gNB 200 and the NCR-Fwd 510A. An access link is established between the UE 100 and the NCR-Fwd 510A. The NCR-Fwd 510A relays a radio signal transmitted between the gNB 200 and the UE 100 via the backhaul link and the access link. The NCR-Fwd 510A changes a propagation state of the radio signal without demodulating or modulating the radio signal.

A control link is established between the gNB 200 and the L1/L2 of the NCR-MT 520A. The L1/L2 of the NCR-MT 520A transmits and/or receives L1/L2 signaling to and from the gNB 200 via the control link. An RRC connection is established between the gNB 200 and the RRC of the NCR-MT 520A. The RRC of the NCR-MT 520A transmits and/or receives an RRC message to and from the gNB 200 via the RRC connection. The NCR-MT 520A receives downlink signaling (also referred to as an “NCR control signal” or simply “control signal”) from the gNB 200 via the RRC connection and/or the control link.

The gNB 200 (transmitter 210) transmits the NCR control signal to the NCR-MT 520A. The NCR control signal may be an RRC message, which is a control signal of the RRC layer (that is, layer 3). The NCR control signal may be a MAC control element (CE), which is a control signal of the MAC layer (that is, layer 2). The NCR control signal may be downlink control information (DCI), which is a control signal of the PHY layer (that is, layer 1). The NCR control signal may be UE-specific signaling. The NCR control signal may be broadcast signaling. The NCR control signal may be a fronthaul message (for example, F1-AP message). When the NCR-MT 520A is a type or part of a base station, the NCR-MT 520A may communicate with the gNB 200 via an AP of Xn (Xn-AP), which is an inter-base station interface.

Hereinafter, the NCR control signal transmitted in the RRC message (and/or MAC CE) and used for static or semi-static control of the NCR-Fwd 510A is also referred to as “NCR configuration information” or simply “configuration information”. Such configuration information may be referred to as “side control configuration”. Here, the RRC message may be an RRC reconfiguration message. The NCR configuration information includes, for example, information for configuring ON/OFF of the NCR-Fwd 510A. The NCR configuration information may include, for example, information for semi-static beam configuration of the NCR-Fwd 510A.

On the other hand, the NCR control signal transmitted in the L1/L2 signaling, that is, the DCI (and/or MAC CE) and used for dynamic control of the NCR-Fwd 510A is also referred to as “NCR control information” or simply “control information”. The NCR control information may be referred to as “side control information”. Cyclic redundancy code (CRC) bits of the PDCCH carrying the NCR control information are scrambled by a newly introduced dedicated RNTI. The dedicated RNTI is also referred to as “NCR-RNTI”. The NCR control information may include, for example, information for dynamic beam control of the NCR-Fwd 510A. The NCR configuration information may include information for instructing dynamic On/Off of the NCR-Fwd 510A.

For example, when the NCR-MT 520A is in an RRC connected state, the NCR apparatus 500A can turn on or off the NCR-Fwd 510A according to the NCR control information received from the gNB 200. On the other hand, after the NCR-MT 520A transitions to an RRC inactive state, the NCR apparatus 500A can turn on or off the NCR-Fwd 510A in accordance with the latest (last) configuration information received from the gNB 200.

Further, the NCR control signal (for example, NCR configuration information by RRC and/or NCR control information by L1/L2 signaling) held by the NCR apparatus 500A (NCR-MT 520A) may be referred to as an NCR-Fwd context.

When a radio link failure (RLF) with the gNB 200 is detected by the NCR-MT 520A, the NCR-MT 520A executes cell selection and triggers RRC connection re-establishment (also referred to as “RRC re-establishment”). Here, when the NCR-MT 520A enters the RRC idle state because a suitable cell cannot be found in the cell selection, the NCR apparatus 500A turns off the NCR-Fwd 510A. The NCR-Fwd 510A is off during an RRC connection re-establishment procedure.

The NCR control signal may include frequency control information designating a center frequency of a radio signal (for example, a component carrier) that is a relay target in the NCR-Fwd 510A. When the NCR control signal received from the gNB 200 includes the frequency control information, the NCR-MT 520A (controller 523) controls the NCR-Fwd 510A such that the NCR-Fwd 510A relays a radio signal whose center frequency is indicated by the frequency control information as a target (step S2A). The NCR control signal may include a plurality of pieces of frequency control information designating center frequencies different from each other. Since the NCR control signal includes the frequency control information, the gNB 200 can designate the center frequency of the radio signal to be relayed by the NCR-Fwd 510A via the NCR-MT 520A.

The NCR control signal may include mode control information designating an operation mode of the NCR-Fwd 510A. The mode control information may be associated with the frequency control information (center frequency). The operation mode may be any one of a mode in which the NCR-Fwd 510A performs non-directional transmission and/or reception, a mode in which the NCR-Fwd 510A performs fixed-directional transmission and/or reception, a mode in which the NCR-Fwd 510A performs transmission and/or reception with a variable directional beam, and a mode in which the NCR-Fwd 510A performs Multiple Input Multiple Output (MIMO) relay transmission. The operation mode may be either a beamforming mode (that is, a mode in which improvement of a desired wave is emphasized) and a null steering mode (that is, a mode in which curbing of an interference wave is emphasized). When the NCR control signal received from the gNB 200 includes the mode control information, the NCR-MT 520A (controller 523) controls the NCR-Fwd 510A such that the NCR-Fwd 510A operates in the operation mode indicated by the mode control information (step S2A). Since the NCR control signal includes the mode control information, the gNB 200 can designate the operation mode of the NCR-Fwd 510A via the NCR-MT 520A.

Here, a mode in which the NCR apparatus 500A performs omnidirectional transmission and/or reception is a mode in which the NCR-Fwd 510A performs relaying in all directions, and may be referred to as an omni mode. The mode in which the NCR-Fwd 510A performs fixed-directional transmission and/or reception may be a directivity mode realized by one directional antenna. The mode may be a beamforming mode realized by applying fixed phase and amplitude control (antenna weight control) to a plurality of antennas. Any of these modes may be designated (set) from the gNB 200 to the NCR-MT 520A. The mode in which the NCR-Fwd 510A performs transmission and/or reception with a variable directional beam may be a mode for performing analog beamforming. The mode may be a mode in which digital beamforming is performed. The mode may be a mode in which hybrid beamforming is performed. The mode may be a mode for forming an adaptive beam specific to the UE 100. Any of these modes may be designated (set) from the gNB 200 to the NCR-MT 520A. In the operation mode in which beamforming is performed, beam control information to be described below may be provided from the gNB 200 to the NCR-MT 520A. The mode in which the NCR apparatus 500A performs MIMO relay transmission may be a mode for performing single-user (SU) spatial multiplexing. The mode may be a mode for performing Multi-User (MU) spatial multiplexing. The mode may be a mode for performing transmission diversity. Any of these modes may be designated (set) from the gNB 200 to the NCR-MT 520A. The operation mode may include a mode in which relay transmission by the NCR-Fwd 510A is turned on (activated) and a mode in which the relay transmission by the NCR-Fwd 510A is turned off (deactivated). Any of these modes may be designated (set) from the gNB 200 to the NCR-MT 520A in the NCR control signal.

The NCR control signal may include beam control information designating a transmission direction, a transmission weight, or a beam pattern when the NCR-Fwd 510A performs directional transmission. The beam control information may be associated with the frequency control information (center frequency). The beam control information may include a precoding matrix indicator (PMI). The beam control information may include beamforming angle information. When the NCR control signal received from the gNB 200 includes beam control information, the NCR-MT 520A (controller 523) controls the NCR-Fwd 510A to form a transmission directivity (beam) indicated by the beam control information. When the NCR control signal includes the beam control information, the gNB 200 can control the transmission directivity of the NCR apparatus 500A via the NCR-MT 520A.

The NCR control signal may include output control information designating a degree to which the NCR-Fwd 510A amplifies the radio signal (amplification gain) or the transmission power. The output control information may be information indicating a difference value (that is, a relative value) between a current amplification gain or transmission power and a target amplification gain or transmission power. When the NCR control signal received from the gNB 200 includes output control information, the NCR-MT 520A (controller 523) controls the NCR-Fwd 510A so that the NCR-Fwd 510A performs change to the amplification gain or transmission power indicated by the output control information. The output control information may be associated with frequency control information (center frequency). The output control information may be information designating any one of an amplification gain, a beamforming gain, and an antenna gain of the NCR-Fwd 510A. The output control information may be information designating transmission power of the NCR-Fwd 510A.

When one NCR-MT 520A controls the plurality of NCR-Fwds 510A, the gNB 200 (transmitter 210) may transmit an NCR control signal to the NCR-MT 520A for each NCR-Fwd 510A. In this case, the NCR control signal may include an identifier of the corresponding NCR-Fwd 510A (NCR identifier). The NCR-MT 520A (controller 523) controlling the plurality of NCR-Fwds 510A determines the NCR-Fwd 510A to which the NCR control signal is applied, based on the NCR identifier included in the NCR control signal received from the gNB 200. The NCR identifier may be transmitted together with the NCR control signal from the NCR-MT 520A to the gNB 200 even when the NCR-MT 520A controls only one NCR-Fwd 510A.

Thus, the NCR-MT 520A (controller 523) controls the NCR-Fwd 510A based on the NCR control signal from the gNB 200. This enables the gNB 200 to control the NCR-Fwd 510A via the NCR-MT 520A.

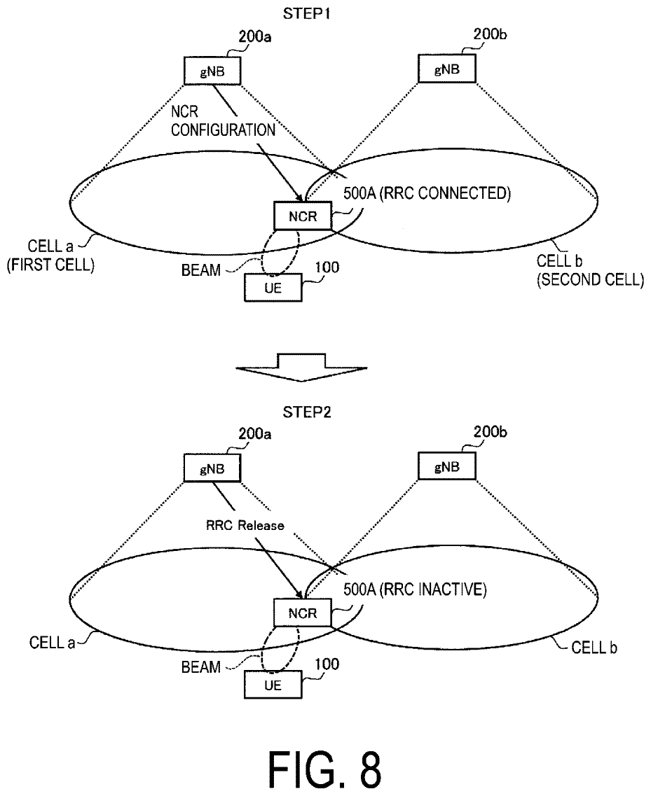

FIG. 8 is a diagram illustrating an example of an operation of the mobile communication system 1 according to the first embodiment.

As illustrated in STEP 1 of FIG. 8, the NCR apparatus 500A is in the RRC connected state in a cell a (a first cell) of a gNB 200a. The gNB 200a transmits the RRC Reconfiguration message including the NCR configuration to the NCR apparatus 500A. The NCR apparatus 500A receives the RRC Reconfiguration message including the NCR configuration from the gNB 200a (cell a), and performs a relay operation by use of the NCR configuration. For example, the NCR configuration includes the periodic beam indication. In the periodic beam indication, the period configuration and the beam configuration are made by the RRC. The NCR apparatus 500A performs periodic beamforming based on the periodic beam indication.

As illustrated in STEP 2 of FIG. 8, the gNB 200a transmits an RRC Release message including a suspend configuration to the NCR apparatus 500A. The NCR apparatus 500A receives the RRC Release message from the gNB 200a (cell a), and transitions to the RRC inactive state. After the NCR-MT 520A transitions to the RRC inactive state, the NCR-MT 520A controls the NCR-Fwd 510A in accordance with the latest (last) NCR configuration. For example, the NCR-MT 520A controls the NCR-Fwd 510A to continue the periodic beamforming operation in accordance with the NCR configuration (latest configuration) received in STEP 1.

Note that the NCR-MT 520A in the RRC inactive state may perform the cell reselection from the cell a to a cell b. The NCR-MT 520A may turn off the NCR-Fwd 510A (or stops the relay operation) in response to the cell reselection to the cell b.

### (1.3) Example of Configuration of Each Apparatus

In the first embodiment, an example of a configuration of each apparatus in the mobile communication system 1 is described.

### (1.3.1) Example of Configuration of Relay Apparatus

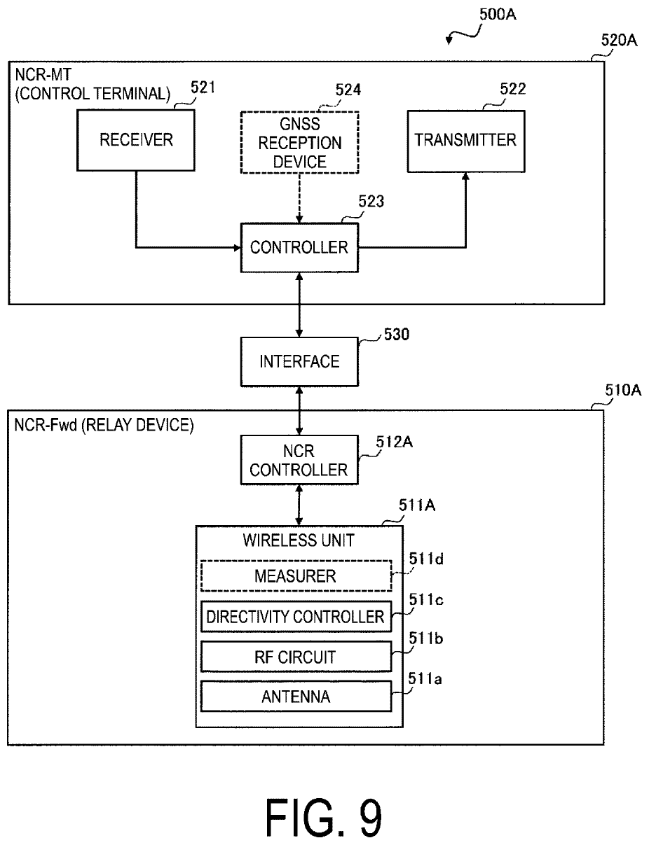

FIG. 9 is a diagram illustrating an example of a configuration of the NCR apparatus 500A according to the first embodiment. The NCR apparatus 500A includes an NCR-Fwd 510A, an NCR-MT 520A, and an interface 530.

The NCR-Fwd 510A includes a wireless unit 511A and an NCR controller 512A. The wireless unit 511A includes an antenna 511a including a plurality of antennas (a plurality of antenna elements), an RF circuit 511b including an amplifier, and a directivity controller 511c that controls directivity of the antenna 511a. The RF circuit 511b amplifies and relays (transmits) radio signals transmitted and/or received by the antenna 511a. The RF circuit 511b may convert a radio signal, which is an analog signal, into a digital signal, and reconvert the digital signal into an analog signal after digital signal processing. The directivity controller 511c may perform analog beamforming through analog signal processing. The directivity controller 511c may perform digital beamforming through digital signal processing. The directivity controller 511c may perform analog and digital hybrid beamforming. The NCR controller 512A controls the wireless unit 511A in response to a control signal from the NCR-MT 520A. The NCR controller 512A may include at least one processor.

The NCR-Fwd 510A may include a measurer 511d that measures a radio environment related to the NCR apparatus 500A (NCR-Fwd 510A) and outputs a measurement result to the NCR controller 512A. The NCR controller 512A outputs the measurement result to the NCR-MT 520A (controller 523) via the interface 530. In the illustrated example, the measurer 511d is provided to the wireless unit 511A of the NCR-Fwd 510A, but the measurer 511d may be provided outside the wireless unit 511A. The measurer 511d may be provided to the NCR-MT 520A.

The measurer 511d may perform measurement on an uplink (UL) signal from the UE 100 to the NCR-Fwd 510A in the access link. The measurer 511d may perform digital detection on (that is, demodulate and measure) the UL signal, and perform measurement of a specific band (for example, a specific physical resource block (PRB) and/or a specific subcarrier). The measurer 511d may include an analog detector instead of a digital detector, and may perform measurement only of full band collective measuring. The measurer 511d may measure a received power and/or received quality of the UL signal in the NCR-Fwd 510A. The received power of the UL signal may be a received power of a UL reference signal (reference signal received power (RSRP). The received quality of the UL signal may be a received quality of a UL reference signal (reference signal received quality (RSRQ) and/or a signal to interference plus noise ratio (SINR). Note that the measurer 511d may be included in the NCR-MT 520A. In this case, the measurer 511d may output the measurement result to the controller 523. Such a configuration is effective when the NCR-Fwd 510A and the NCR-MT 520A operate in the same band and/or when a circuit configuration is adopted in which a component of the wireless unit 511A of the NCR-Fwd 510A (for example, RF circuit 511b) can be measured by the NCR-MT 520A.

The measurer 511d may perform measurement on a downlink (DL) signal from the NCR-Fwd 510A to the UE 100 in the access link. The measurer 511d may perform digital detection on the DL signal fed back from a transmission end (antenna end) of the NCR-Fwd 510A, and perform measurement of a specific band (for example, a specific physical resource block (PRB) and/or a specific subcarrier). The measurer 511d may include an analog detector instead of a digital detector, and may perform measurement only of full band collective measuring. The measurer 511d may measure a transmission power of the DL signal in the NCR-Fwd 510A, for example, a full band power ([dBm]) or a partial band power ([dBm]). The measurer 511d may acquire a gain ([dB]) configured for the NCR-Fwd 510A as a measured value. The measurer 511d may perform measurement of the gain of the NCR-Fwd 510A by providing a detector to a reception end (antenna end) of the NCR-Fwd 510A.

The measurer 511d may perform measurement on a UL signal from the NCR-Fwd 510A to the gNB 200 in the backhaul link. The measurer 511d may perform digital detection on the UL signal fed back from the transmission end (antenna end) of the NCR-Fwd 510A, and perform measurement of a specific band (for example, a specific physical resource block (PRB) and/or a specific subcarrier). The measurer 511d may include an analog detector instead of a digital detector, and may perform measurement only of full band collective measuring. The measurer 511d may measure a transmission power of the UL signal in the NCR-Fwd 510A, for example, a full band power ([dBm]) or a partial band power ([dBm]). The measurer 511d may acquire a gain ([dB]) configured for the NCR-Fwd 510A as a measured value. The measurer 511d may perform measurement of the gain of the NCR-Fwd 510A by providing a detector to the reception end (antenna end) of the NCR-Fwd 510A.

The measurer 511d may perform measurement on a DL signal from the gNB 200 to the NCR-Fwd 510A in the backhaul link. For measuring the DL signal from the gNB 200 to the NCR-Fwd 510A, the measurer 511B may be at least partially shared with the receiver 521 of the NCR-MT 520A. The measurer 511d may perform digital detection on (that is, demodulate and measure) the DL signal, and perform measurement of a specific band (for example, a specific physical resource block (PRB) and/or a specific subcarrier). The measurer 511d may include an analog detector instead of a digital detector, and may perform measurement only of full band collective measuring. The measurer 511d may measure a received power and/or received quality of the DL signal in the NCR-Fwd 510A. The received power of the DL signal may be a received power of a DL reference signal (RSRP). The received quality of the DL signal may be a received quality (RSRQ) and/or an SINR of the DL reference signal.

The NCR-MT 520A includes a receiver 521, a transmitter 522, and a controller 523. The receiver 521 performs various types of reception under control of the controller 523. The receiver 521 includes an antenna and a reception device. The reception device converts a radio signal received by the antenna (radio signal) into a baseband signal (a reception signal) and outputs the reception signal to the controller 523. The transmitter 522 performs various types of transmission under control of the controller 523. The transmitter 522 includes an antenna and a transmission device. The transmission device converts a baseband signal (a transmission signal) output by the controller 523 into a radio signal and transmits the radio signal from the antenna. The controller 523 performs various types of controls in the NCR-MT 520A. The operation of the NCR-MT 520A (and the NCR apparatus 500A) described above and to be described below may be an operation controlled by the controller 523. The controller 523 includes at least one processor and at least one memory. The memory stores a program to be executed by the processor and information to be used for processing by the processor. The processor may include a baseband processor and a Central Processing Unit (CPU). The baseband processor performs modulation and demodulation, coding and decoding, and the like of a baseband signal. The CPU executes the program stored in the memory to thereby perform various types of processing. The controller 523 executes a function of at least one layer selected from the group consisting of the PHY, the MAC, the RRC, and the F1-AP.

The NCR-MT 520A may include a global navigation satellite system (GNSS) reception device 524. The GNSS reception device 524 receives a satellite signal from a positioning satellite, and outputs GNSS location information indicating a geographical location of the NCR apparatus 500A (NCR-MT 520A) to the controller 523. The GNSS location information includes at least one of a latitude, a longitude, or an altitude. Note that the GNSS reception device 524 may be provided to the NCR-Fwd 510A or the interface 530. Note that, when a plurality of NCR-Fwds 510A exist, the GNSS reception device 524 may be provided to each of the plurality of NCR-Fwds 510A.

The interface 530 electrically or logically connects the NCR-Fwd 510A and the NCR-MT 520A. The controller 523 of the NCR-MT 520A controls the NCR-Fwd 510A via the interface 530. The interface 530 may be a logical entity of an upper layer (for example, an application layer).

In the first embodiment, the receiver 521 of the NCR-MT 520A receives signaling (NCR control signal) used for control of the NCR apparatus 500A from the gNB 200 through wireless communication. The controller 523 of the NCR-MT 520A controls the NCR apparatus 500A based on the signaling. This enables the gNB 200 to control the NCR-Fwd 510A via the NCR-MT 520A.

### (1.3.2) Example of Configuration of User Equipment

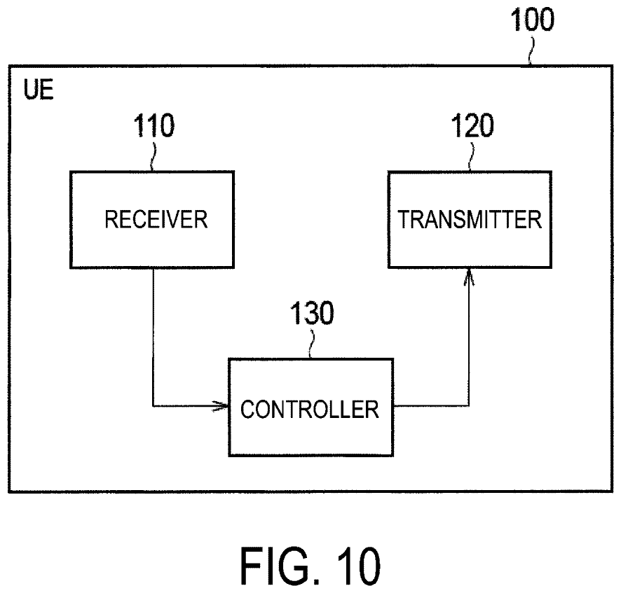

FIG. 10 is a diagram illustrating a configuration of the UE 100 (user equipment) according to the first embodiment. The UE 100 includes a receiver 110, a transmitter 120, and a controller 130. The receiver 110 and the transmitter 120 constitute a wireless communicator that performs wireless communication with the gNB 200.

The receiver 110 performs various types of reception under control of the controller 130. The receiver 110 includes an antenna and a reception device. The reception device converts a radio signal received through the antenna into a baseband signal (a reception signal) and outputs the resulting signal to the controller 130.

The transmitter 120 performs various types of transmission under control of the controller 130. The transmitter 120 includes an antenna and a transmission device. The transmission device converts a baseband signal (a transmission signal) output by the controller 130 into a radio signal and transmits the resulting signal through the antenna.

The controller 130 performs various types of control and processing in the UE 100. Such processing includes processing of respective layers to be described later. The operations of the UE 100 described above and to be described below may also be an operation under the control of the controller 130. The controller 130 includes at least one processor and at least one memory. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory to thereby perform various types of processing.

### (1.3.3) Example of Configuration of Base Station

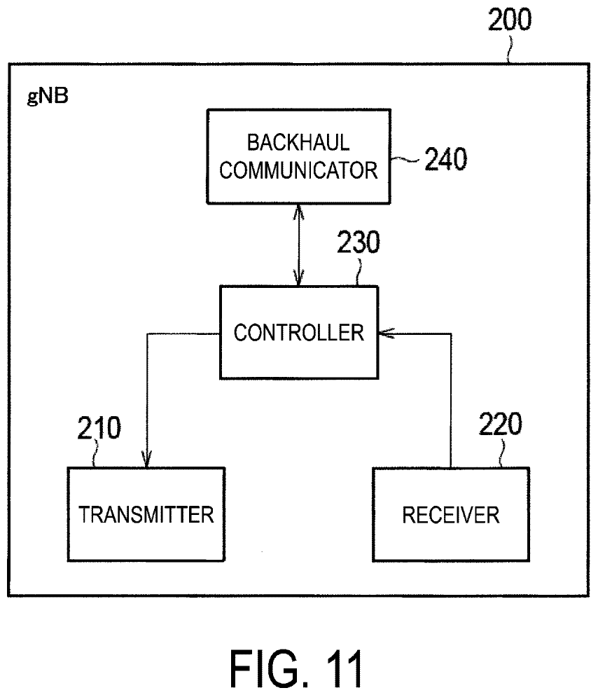

FIG. 11 is a diagram illustrating an example of a configuration of the gNB 200 (base station) according to the first embodiment. The gNB 200 includes a transmitter 210, a receiver 220, a controller 230, and a backhaul communicator 240.

The transmitter 210 performs various types of transmission under control of the controller 230. The transmitter 210 includes an antenna and a transmission device. The transmission device converts a baseband signal (a transmission signal) output by the controller 230 into a radio signal and transmits the resulting signal through the antenna. The receiver 220 performs various types of reception under control of the controller 230. The receiver 220 includes an antenna and a reception device. The reception device converts a radio signal received through the antenna into a baseband signal (a reception signal) and outputs the resulting signal to the controller 230. The transmitter 210 and the receiver 220 may be capable of beamforming using a plurality of antennas.

The controller 230 performs various types of control for the gNB 200. The operations of the gNB 200 described above and below may be also performed under the control of the controller 230. The controller 230 includes at least one processor and at least one memory. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory to thereby perform various types of processing.

The backhaul communicator 240 is connected to a neighboring base station via the inter-base station interface. The backhaul communicator 240 is connected to the AMF/UPF 300 via the interface between a base station and the core network. The gNB may include a Central Unit (CU) and a Distributed Unit (DU) (that is, functions are divided), and both units may be connected via an F1 interface.

In the first embodiment, the transmitter 210 of the gNB 200 transmits signaling (NCR control signal) used for control of the NCR-Fwd 510A to the NCR-MT 520A through wireless communication. This enables the gNB 200 to control the NCR apparatus 500A via the NCR-MT 520A.

### (1.4) Operation according to First Embodiment

The NCR apparatus 500A can extend the coverage of the gNB 200 while suppressing occurrence of interference by, for example, amplifying a radio signal received from the gNB 200 and transmitting the radio signal through directional transmission. Network optimization may be achieved and an introduction effect of the NCR apparatus 500A may be enhanced by the network autonomously adjusting configuration parameters for the NCR apparatus 500A or by the network autonomously changing an operation of the NCR apparatus 500A. In the first embodiment, an operation for facilitating realization of the network optimization is described.

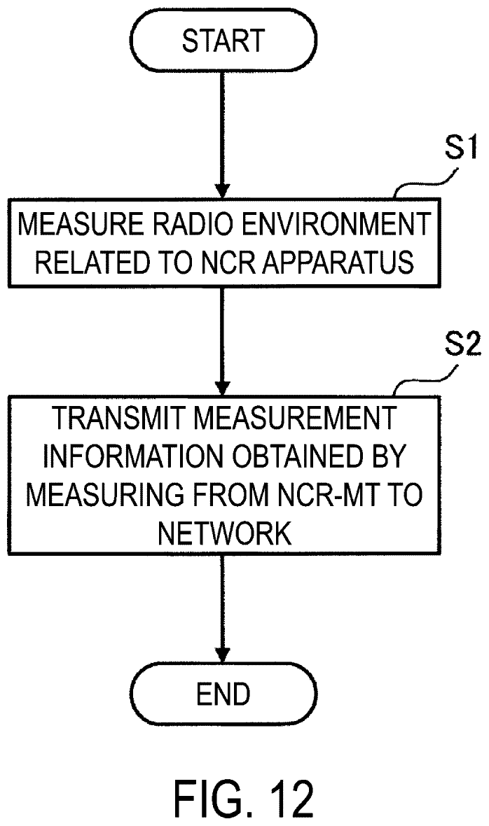

FIG. 12 is a flowchart illustrating an operation of the NCR apparatus 500A according to the first embodiment. The NCR apparatus 500A includes the NCR-Fwd 510A and the NCR-MT 520A, as described above, the NCR-Fwd 510A performing a relay operation of relaying a radio signal transmitted between the network 5 and the UE 100, the NCR-Fwd 510A receiving a control signal used for control of the NCR-MT 520A from the network 5.

In step S1, the NCR apparatus 500A measures the radio environment related to the NCR apparatus 500A.

In step S2, the NCR apparatus 500A transmits measurement information obtained by the measuring in step S1 from the NCR-MT 520A to the network 5.

This allows the network 5 to grasp the radio environment related to the NCR apparatus 500A based on the measurement information, facilitating realization of the network optimization.

In the first embodiment, step S1 may include a step of measuring the radio environment of the access link between the NCR apparatus 500A and the UE 100. The radio environment of the access link is information that the gNB 200 does not directly know. The network 5 can grasp the radio environment of the access link based on the measurement information, facilitating realization of the network optimization to optimize the access link.

In the first embodiment, the step of measuring the radio environment of the access link may include a step of measuring a received power and/or a received quality of a UL radio signal received by the NCR apparatus 500A from the UE 100. The step of measuring the radio environment of the access link may include a step of measuring a transmission power of a DL radio signal transmitted from the NCR apparatus 500A to the UE 100. Step S1 may include a step of measuring a transmission power of a UL radio signal transmitted from the NCR apparatus 500A to the network 5. Such an operation is be described in detail in the first operation pattern of the first embodiment described later.

In the first embodiment, step S1 may include a step of measuring and holding the radio environment in response to off control being performed to switch the NCR-Fwd 510A from an on state to an off state. Such an operation is be described in detail in a second operation pattern of the first embodiment described later. Note that step S1 may include a step of measuring and holding the radio environment, triggered by any of 1) a beam failure occurring, 2) a beam recovery being performed, and 3) a beam different from the current being selected resulting from the beam recovery. Step S1 may include a step of measuring and holding the radio environment in response to the NCR-MT 520A transitioning to the RRC idle state or the RRC inactive state.

In the first embodiment, step S1 may include a step of measuring a state of a beam formed by the gNB 200. Such an operation is be described in detail in a third operation pattern of the first embodiment described later.

In the first embodiment, step S1 may include a step of measuring the radio environment when the NCR-MT 520A is in the RRC connected state. Step S2 may include a step of transmitting the measurement information to the network 5 when the NCR-MT 520A is in the RRC connected state. This allows for more real-time feedback.

In the first embodiment, the NCR apparatus 500A may hold the measurement information as a log when the NCR-MT 520A is in the RRC idle state or the RRC inactive state. Step S2 may include a step of transmitting the held measurement information (log) to the network 5 when the NCR-MT 520A is in the RRC connected state. This allows the network 5 to know the radio environment when the NCR-MT 520A is in the RRC idle state or the RRC inactive state.

Step S1 may include a step of acquiring location information indicating a location of the NCR apparatus 500A at the time of the measuring. The location information may be the GNSS location information. The NCR apparatus 500A (NCR-MT 520A) may acquire the location information based on a positioning reference signal received from the network 5. Step S2 may include a step of transmitting the measurement information and the location information associated with the measurement information to the network 5. This allows the network 5 to grasp the radio environment related to the NCR apparatus 500A per location, facilitating realization of the network optimization.

### (1.4.1) First Operation Pattern

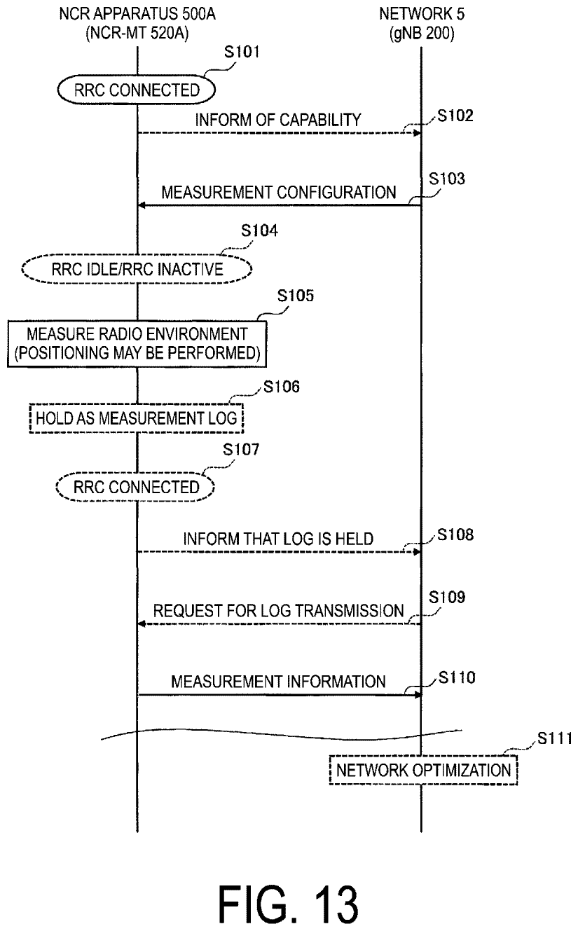

In the first embodiment, the first operation pattern is described with reference to FIG. 13.

The information that the gNB 200 does not directly know includes the state of access link between the NCR apparatus 500A and the UE 100. For example, the gNB 200 cannot grasp a received power and/or received quality of a UL signal transmitted from the UE 100 and received by the NCR-Fwd 510A. The gNB 200 also cannot grasp a transmission power of a DL signal of the NCR-Fwd 510A transmitted from the NCR-Fwd 510A to the UE 100. In a situation where the NCR-Fwd 510A is autonomously performing transmission power control (gain control), the gNB 200 cannot grasp a transmission power of a UL signal of the NCR-Fwd 510A transmitted from the NCR-Fwd 510A to the gNB 200. Therefore, reporting these pieces of information from the NCR-MT 520A to the network 5 facilitates realization of the network optimization.

As illustrated in FIG. 13, in step S101, the NCR-MT 520A is in the RRC connected state in a cell of the gNB 200.

In step S102, the NCR-MT 520A may inform the gNB 200 of measuring capability of the NCR-MT 520A itself. For example, the NCR-MT 520A transmits a UE Capability Information message including information on the measuring capability of the NCR-MT 520A itself to the gNB 200 in response to an inquiry from the gNB 200. The measuring capability corresponds to each content of configurations described later.

In step S103, the gNB 200 configures measuring of the radio environment for the NCR-MT 520A. For example, the gNB 200 transmits an RRC message including at least one selected from the group consisting of 1) to 5) below to the NCR-MT 520A.
1) Configuration of Measurement Scheme:

As a measurement scheme, either of Immediate MDT (Minimization of Drive Test) and Logged MDT is configured for the NCR-MT 520A. Immediate MDT is a scheme for the NCR-MT 520A in the RRC connected state to immediately report the measurement result to the network 5. Logged MDT is a scheme for the NCR-MT 520A in the RRC idle state or the RRC inactive state holds (logs) the measurement result and reports the measurement result to the network 5 later.
2) Configuration of NCR-Fwd 510A to be Measured:

In particular, in the case of a configuration in which the NCR apparatus 500A includes a plurality of NCR-Fwds 510A, a measurement configuration in step S103 includes an identifier indicating the NCR-Fwd 510A to be measured.
3) Configuration of Measurement Contents:

The measurement contents are basically measured values at the transmission and reception ends (antenna ends) of the NCR-Fwd 510A. As the measurement contents, at least one selected from the group consisting of 3-1) to 3-4) below may be configured for the NCR-MT 520A.
3-1) UL reception measurement of access link:

A UL reception measurement of the access link may be a measurement of a received power ([dBm]) such as the RSRP. The UL reception measurement may be measurement of a received quality ([dB]) such as the RSRQ or the SINR. The UL reception measurement of the access link may be a received power and/or received quality of a partial band.
3-2) DL transmission measurement of access link:

A DL transmission measurement of the access link may be a power of a full band ([dBm]) and/or a gain of the NCR-Fwd 510A ([dB]). The DL transmission measurement of the access link may be a power of a partial band ([dBm]) and/or a gain of the NCR-Fwd 510A ([dB]). Note that the term “gain” as used herein may refer to an amplification gain (the same applies hereinafter).
3-3) UL transmission measurement of backhaul link:

A UL transmission measurement of the backhaul link may be a power of a full band ([dBm]) and/or a gain of the NCR-Fwd 510A ([dB]). The UL transmission measurement of the backhaul link may be a power of a partial band ([dBm]) and/or a gain of the NCR-Fwd 510A ([dB]).
3-4) DL reception measurement of backhaul link:

A DL reception measurement of the backhaul link may be a received power ([dBm]) such as the RSRP. The DL reception measurement of the backhaul link may be a received quality ([dB]) such the RSRQ/SINR. The DL reception measurement of the backhaul link may be a received power and/or a received quality of a partial band.
4) Configuration of frequency/time to be measured:

A configuration of a frequency/time to be measured may be a frequency-related configuration, for example, a combination of a center frequency and a bandwidth, or a combination of a lower limit frequency and an upper limit frequency. The frequency-related configuration may be a combination of a starting PRB number and the number of PRBs, or a combination of a starting subcarrier number and the number of subcarriers. The configuration of the time to be measured may be a configuration in a time direction, for example, a combination of a starting radio frame number (SFN) and a period. The configuration in the time direction may be a configuration in units of slots, subframes, or symbols.
5) Configuration of type of trigger event for logging or reporting:

As the type of logging or reporting, any of 5-1) to 5-3) below may be configured for the NCR-MT 520A.
5-1) Event trigger:

The NCR-MT 520A performs measurement of the radio environment and performs logging (for Logged MDT) or reporting (for Immediate MDT) triggered by the measurement result (RSRP/RSRQ/SINR or the measured values pursuant thereto) exceeding or falling below a threshold. Such a threshold may be configured for the NCR-MT 520A. A time-to-trigger (TTT) may be configured for the NCR-MT 520A. When the TTT is configured, the NCR-MT 520A triggers logging or reporting in response to a threshold condition being met for the time of the TTT.
5-2) Event-triggered periodic:

The NCR-MT 520A starts logging or reporting from when the above event occurs, and performs logging or reporting at a certain periodicity (for a certain duration). A certain periodicity and/or a certain duration may be configured for the NCR-NW MT 520A.

### 5-3) Periodic:

A periodicity for logging or reporting may be configured for the NCR-MT 520A.

In step S104, the NCR-MT 520A may transition to the RRC idle state or the RRC inactive state (for Logged MDT). The NCR-MT 520A may remain in the RRC connected state (for Immediate MDT).

In step S105, the NCR-MT 520A performs at least one measurement selected from the group consisting of 1) to 4) below according to the contents of the configuration of step S103.
1) UL reception measurement of access link:

The NCR-MT 520A performs measurement of a UL signal from the UE 100. The NCR-MT 520A may perform measurement of a specific band (specific PRB, specific subcarrier). The NCR-MT 520A may perform measurement of full band collective measuring.
2) DL transmission measurement of access link:

When the NCR-Fwd 510A has an analog detector at the transmission end (antenna end), full band collective measuring may be performed. When the feedback is performed from the transmission end (antenna end) of the NCR-Fwd 510A to the NCR-MT 520A and the digital detection (demodulation and measurement) is performed, a power of a partial band may be measured. A gain configured for the NCR-Fwd 510A may be also acquired as a measured value. Or, measurement of the gain of the NCR-Fwd 510A may be performed by providing a detector to the reception end (antenna end) of the NCR-Fwd 510A.
3) UL transmission measurement of backhaul link:

The assumptions are made which are the same as for the DL transmission measurement of the access link above.
4) DL reception measurement:

The measurement is performed by the receiver 521 (detector) of the NCR-MT 520A.

Steps S106 to S109 are operations for Logged MDT.

In step S106, the NCR-MT 520A in the RRC idle state or the RRC inactive state may hold the measurement result of step S105 as a log (logging). Here, the NCR-MT 520A may hold additional information such as a measurement date and time (time stamp) of the step S105 and a measurement location (latitude/longitude/altitude) of the step S105 in addition to the measurement result.

In step S107, the NCR-MT 520A in the RRC idle state or the RRC inactive state may transition to the RRC connected state.

In step S108, the NCR-MT 520A informs the network 5 (gNB 200) that it has a log at the time of RRC connection establishment or recovery.

In step S109, the network 5 (gNB 200) transmits UE Information Request to the NCR-MT 520A.

In step S110, the NCR-MT 520A in the RRC connected state transmits a UE Information Response message including the log to the network 5 (gNB 200).

On the other hand, for Immediate MDT, in step S110, the NCR-MT 520A in the RRC connected state transmits a Measurement Report message including the measurement result of step S105 to the network 5 (gNB 200). The NCR-MT 520A may transmit uplink control information (UCI) including the measurement result of step S105 on a physical up-link control channel (PUCCH). The NCR-MT 520A may transmit a MAC Control Element (CE) including the measurement result of the step S105. The report of the step S110 may include additional information such as the measurement location (latitude/longitude/altitude) of the step S105.

In step S111, the network 5 (gNB 200) may perform at least one operation selected from the group consisting of 1) to 3) below using the information of step S110.
1) Optimize the transmission power of the gNB 200 (or transmission power distribution per UE 100):

For example, when the gain of the NCR apparatus 500A is sufficient for the UE 100 under control of the NCR apparatus 500A, the transmission power from the gNB 200 is adjusted to be lowered (that is, the NCR apparatus 500A is still amplified properly and the same degree of power is provided to the UE 100).
2) Optimize the coverage by the NCR apparatus 500A:

For example, when the DL input SINR to the NCR apparatus 500A is poor, an antenna installation position of the NCR apparatus 500A is moved closer to the gNB 200, or an antenna directivity direction of the NCR apparatus 500A is adjusted to a direction of the gNB 200 (or a direction in which an interferences is reduced).
3) Grasp whether the UE 100 is under control of the NCR apparatus 500A and/or an existence probability, and optimize the operation of the NCR apparatus 500A.

For example, in a time period in which the UE 100 is not so much under control of the NCR apparatus 500A, the NCR apparatus 500A is made to transition down to the RRC idle state.

Note that, when the NCR apparatus 500A can grasp the number of UEs 100 under control of the NCR apparatus 500A itself, the NCR apparatus 500A may log or report this information. For example, the NCR apparatus 500A may detect whether the UE 100 is under control of the NCR apparatus 500A itself using a proximity sensor and/or a radar.

### (1.4.2) Second Operation Pattern

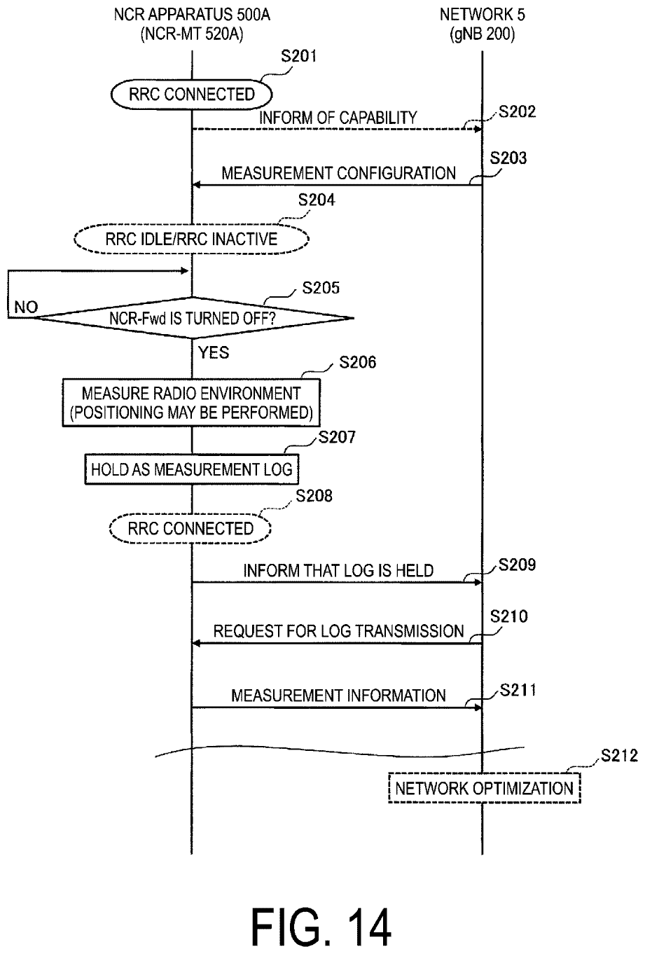

The second operation pattern of the first embodiment is described mainly focusing on differences from the above-described first operation pattern with reference to FIG. 14. The second operation pattern may be implemented in combination with the first operation pattern described above.

As described above, the NCR-Fwd 510A is assumed to be controlled to be turned off in various events. The event is, for example, at least one selected from the group consisting of 1) to 5) below.
1) The NCR-MT 520A in the RRC inactive state reselects a cell different from the cell for which the latest configuration is performed.
2) The NCR-MT 520A in the RRC connected state detects a radio link failure (RLF) and initiates RRC re-establishment.
3) The NCR-MT 520A in the RRC inactive state transitions to the RRC idle state.
4) The NCR-MT 520A in the RRC inactive state cannot find a Suitable cell and camps on an Acceptable cell, or enters a camped on any cell state.
5) The NCR-MT 520A detects a beam failure or fails in a beam failure recovery.

These can be said to be abnormal states in which the NCR-Fwd 510A is not intentionally turned off from the viewpoint of the network 5. Therefore, it is considerable that the radio environment when the NCR-Fwd 510A is controlled to be turned off are held (logged), and thereby, the radio environment can be used for the network optimization. In the second operation pattern, the NCR-MT 520A measures and holds the radio environment in response to the off control being performed to switch the NCR-Fwd 510A from an on state to an off state.

As illustrated in FIG. 14, in step S201, the NCR-MT 520A is in the RRC connected state in a cell of the gNB 200.

In step S202, the NCR-MT 520A may inform the gNB 200 of measuring capability of the NCR-MT 520A itself. For example, the NCR-MT 520A transmits a UE Capability Information message including information on the measuring and holding capability when the NCR-Fwd 510A is in the off state to the gNB 200 in response to an inquiry from the gNB 200.

In step S203, the gNB 200 may configure the NCR-MT 520A to keep a record of the NCR-Fwd 510A in the off state (when the NCR apparatus 500A autonomously controls the NCR-Fwd 510A to be turned off). The configuration may include configuration information the same as and/or similar to that of the first operation pattern described above. At this time, the NCR-MT 520A controls the NCR-Fwd 510A (to be on) in accordance with the configuration (NCR configuration information) from the gNB 200. The NCR-MT 520A may be in the RRC connected state or the RRC inactive state (step S204).

In step S205, the NCR-MT 520A determines whether the NCR-Fwd 510A is controlled to be stopped (turned off). When the NCR-Fwd 510A is controlled to be stopped (turned off), at least one selected from the group consisting of 1) to 3) below held as a log in step S206.

### 1) Occurring Event

The NCR-MT 520A includes information indicating an event that has occurred among events 1-1) to 1-6) below in the log.
1-1) A cell different from the cell for which the latest configuration is performed is reselected.
1-2) RRC Reestablishment is started.
1-3) Transition from the RRC inactive state to the RRC idle state. Camping on Acceptable cell in the RRC inactive state, or entering the camped on any cell state may be used.
1-4) Suitable cell cannot be found.
1-5) Beam failure is detected. Failing in Beam failure recovery may be used.
1-6) Other events to perform the off control of the NCR-Fwd 510A may be used.

### 2) Radio Environment

The NCR-MT 520A includes at least one measurement result selected from the group consisting of the radio environments 2-1) to 2-4) below in a log.
2-1) DL received power or received quality (RSRP, RSRQ, SINR) of backhaul link.
2-2) UL transmission power of backhaul link.
2-3) UL received power of access link.
2-4) DL transmission power of access link.
3) The NCR-MT 520A may hold a time (time stamp) of occurrence of the NCR-Fwd 510A being turned off and a location (latitude/longitude/altitude) of the NCR-The Fwd 510A when being in the off state as accompanying information of the log.

Note that, in step S206, the measuring of the radio environment may be stopped in response to the NCR-Fwd 510A being controlled to be turned on (again). The gNB 200 may configure in step S203 that the measuring of the radio environment is stopped when the NCR-Fwd 510A is controlled to be turned on.

Steps S207 to S212 are the same as and/or similar to those of the first operation pattern described above. To be more specific, in step S211, the NCR-MT 520A transmits the log to the gNB 200.

### (1.4.3) Third Operation Pattern

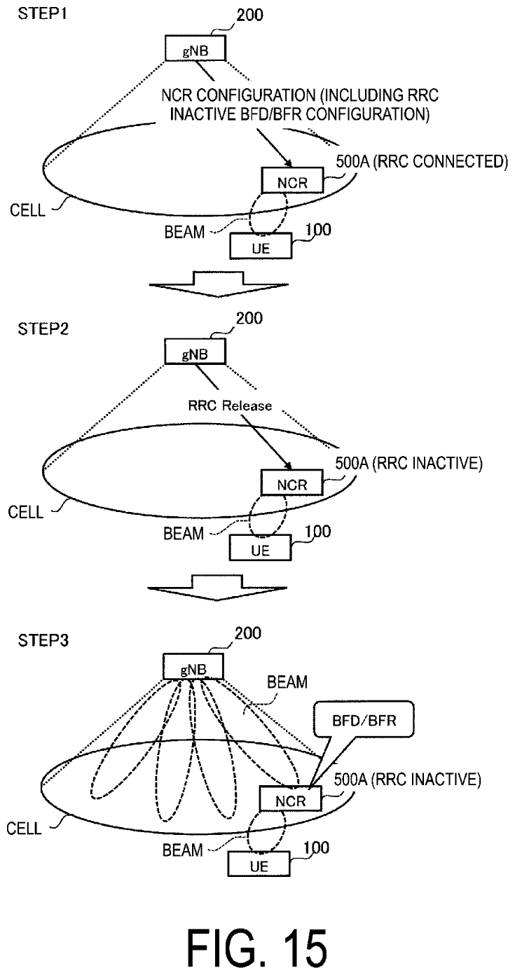

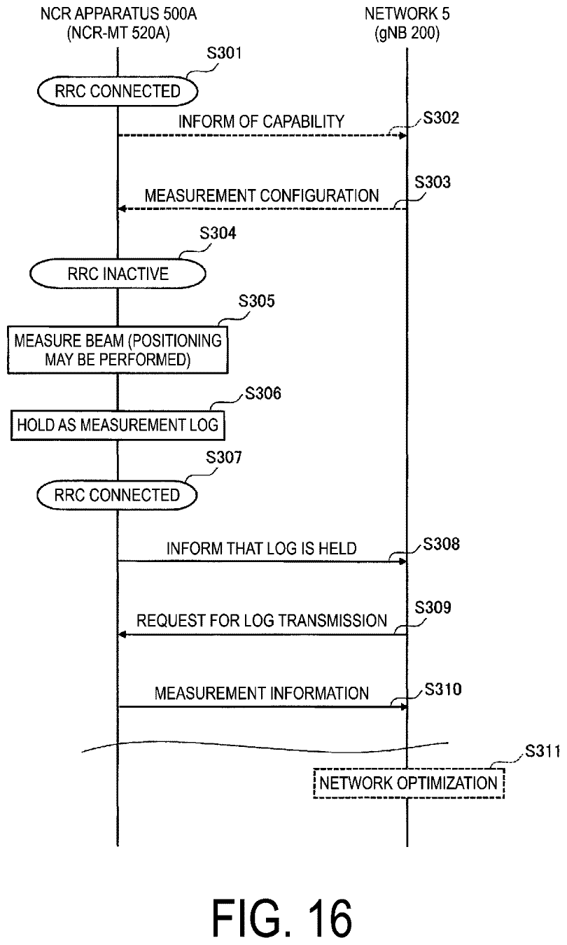

The third operation pattern of the first embodiment is described mainly focusing on differences from the above-described first and second operation patterns with reference to FIGS. 15 and 16. The third operation pattern may be implemented in combination with the first operation pattern and/or the second operation pattern described above.

The third pattern is an operation pattern related to the beam failure detection and recovery performed by the NCR-MT 520A.

First, an overview of general beam failure detection and recovery is described. General beam failure detection (also referred to as “BFD”) and beam failure recovery (also referred to as “BFR”) are performed by the UE 100 in the RRC connected state. For the beam failure detection, the gNB 200 configures an SSB or a channel state information (CSI)-RS as a BFD reference signal (RS) for the UE 100. The MAC entity of the UE 100 in the RRC connected state declares (detects) a beam failure when the number of beam failure instance indications from the physical layer reaches a threshold (maximum count value) configured by the gNB 200 before the timer configured by the gNB 200 expires.

After the beam failure is detected in a primary cell (PCell), the MAC entity of the UE 100 performs the following:
triggering the BFR by initiating a random access procedure in the PCell;
selecting an appropriate beam to perform the BFR (when the gNB 200 provides a dedicated random access resource for a particular beam, it is prioritized by UE 100);
including a beam failure indication in the PCell in a beam failure recovery (BFR) MAC control element (CE) when the random access procedure includes contention-based random access,

When the random access procedure is completed, the UE 100 considers that the BFR in the PCell is completed.

On the other hand, the NCR apparatus 500A may continue the relay operation in accordance with the latest NCR configuration even if the NCR-MT 520A transitions from the RRC connected state to the RRC inactive state, as described above. Therefore, assume that, in the third operation pattern, the NCR-MT 520A even in the RRC inactive state performs the BFD and the BFR.

FIG. 15 is a diagram illustrating an operation scenario for the third operation pattern.

As illustrated in STEP 1 of FIG. 15, the NCR apparatus 500A is in the RRC connected state in a cell of the gNB 200. The gNB 200 transmits the RRC Reconfiguration message including the NCR configuration to the NCR apparatus 500A. The NCR apparatus 500A receives the RRC Reconfiguration message including the NCR configuration from the gNB 200, and performs the relay operation by use of the NCR configuration. The NCR configuration may include the periodic beam indication. That is, the NCR configuration includes information for configuring to perform the relay operation involving the periodic beamforming, and the NCR-Fwd 510A is configured to be turned on. The NCR-MT 520A receives the configuration information regarding the relay operation from the gNB 200.

As illustrated in STEP 2 of FIG. 15, the gNB 200 transmits an RRC Release message including a suspend configuration to the NCR apparatus 500A. The NCR apparatus 500A receives the RRC Release message from the gNB 200, and transitions to the RRC inactive state.

The RRC Reconfiguration message transmitted from the gNB 200 to the NCR-MT 520A in STEP 1 or the RRC Release message transmitted from the gNB 200 to the NCR-MT 520A in STEP 2 may include configuration information regarding whether the NCR-MT 520A in the RRC inactive state performs beam failure detection (BFD) processing with respect to the gNB 200.

As illustrated in STEP 3 of FIG. 15, after the NCR-MT 520A transitions to the RRC inactive state, the NCR-MT 520A controls the NCR-Fwd 510A in accordance with the latest NCR configuration.

Note that the basic operation of the BFD performed by the NCR-MT 520A in the RRC inactive state may be an operation to which the general BFD is applied. The MAC entity of the NCR-MT 520A in the RRC inactive state may perform the BFD by continuously using the BFD reference signal (RS), the timer value, and the maximum count value that are configured from the gNB 200 when the NCR-MT 520A is in the RRC connected state. Specifically, the MAC entity of the NCR-MT 520A in the RRC inactive state declares (detects) a beam failure when the number of beam failure instance indications from the physical layer reaches the threshold (maximum count value) configured by the gNB 200 before the timer configured by the gNB 200 expires. At least one selected from the group consisting of the reference signal (RS), the timer value, and the maximum count value for the RRC inactive state may be a parameter independent of the reference signal (RS), the timer value, and the maximum count value for the RRC connected state.

FIG. 16 is a diagram illustrating an operation of the mobile communication system 1 for the third operation pattern.

As illustrated in FIG. 16, in step S301, the NCR-MT 520A is in the RRC connected state in a cell of the gNB 200.

In step S302, the NCR-MT 520A may inform the gNB 200 of beam measuring capability in the RRC inactive state. For example, the NCR-MT 520A transmits a UE Capability Information message including information on the beam measuring capability in the RRC inactive state to the gNB 200 in response to an inquiry from the gNB 200.

In step S303, the gNB 200 may configure the NCR-MT 520A to perform beam recording in the RRC inactive state. At this time, the NCR-MT 520A in the RRC connected state controls the NCR-Fwd 510A (to be) in accordance with the configuration (NCR configuration information) from the gNB 200.

In step S304, the NCR-MT 520A transitions from the RRC connected state to the RRC inactive state. The NCR-MT 520A continues to control the NCR-Fwd 510A (to be on) in accordance with the latest configuration (the latest NCR configuration information) from the gNB 200.

In steps S305 and S306, the NCR-MT 520A in the RRC inactive state holds at least one piece of information (beam monitoring information during controlling the NCR-Fwd 510A) selected from the group consisting of 1) to 3) below in a log.

### 1) Selected Beam Information

### 1-1) SSB Index of Selected Beam

The NCR-MT 520A may hold the SSB index of the selected beam in a log.

### 1-2) SSB Index of Beam in Which Beam Failure is Detected

The NCR-MT 520A may hold the SSB index of the beam in which the beam failure is detected in a log. The NCR-MT 520A may hold the SSB index of the beam after the beam failure recovery is recovered in a log.

### 2) Radio Environment

For example, the NCR-MT 520A holds the DL received power and/or received quality (RSRP, RSRQ, SINR) of the backhaul link in a log. The NCR-MT 520A may hold the measurement value for each SSB index in association with the SSB index of the selected beam in a log.

Note that, when a channel state information RS (CSI-RS) is used instead of the SSB for identifying a beam, a configuration index of the CSI-RS of the measured beam may be held in a log instead of the SSB index. When the CSI-RS of the measured beam is associated with the SSB, the associated SSB index may be held in the log.

For example, the NCR-MT 520A keeps the following information in the log:
SSB index #10, best beam (selected), RSRP=−80 dBm
SSB index #21, (neighbour beam), RSRP=−88 dBm
SSB index #8, (neighbour beam), RSRP=−93 dBm

3) The NCR-MT 520A may hold a time (time stamp) of occurrence of the measuring or the beam failure and a location (latitude, longitude, and height) of occurrence of the measuring or the beam failure as accompanying information.

The above example of the operation is on the assumption that the NCR-Fwd 510A is in the on state when the NCR-MT 520A is in the RRC inactive state, but the NCR-MT 520A may not need to hold the log when the NCR-Fwd 510A is in the off state in accordance with the latest configuration from the gNB 200.

Steps S307 to S311 are the same as and/or similar to those of the first operation pattern described above. To be more specific, in step S211, the NCR-MT 520A transmits the log to the gNB 200.

### (2) Second Embodiment

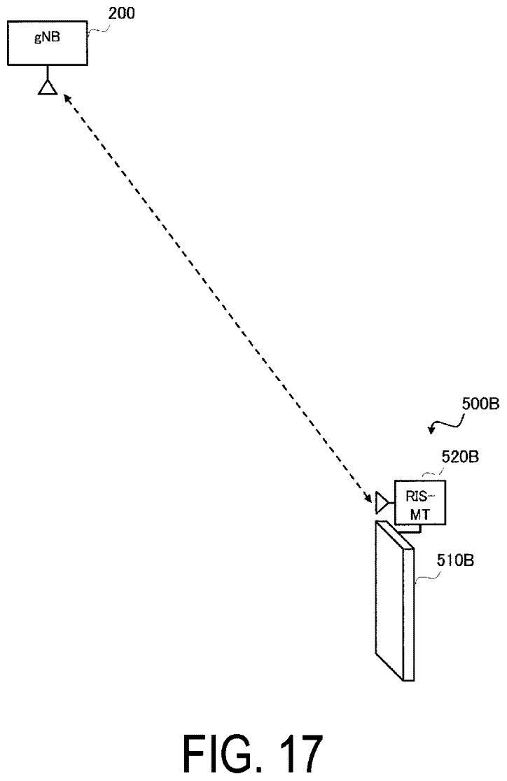

A second embodiment is described mainly focusing on differences from the above-described embodiments. As illustrated in FIG. 17, a relay apparatus according to the second embodiment is a reconfigurable intelligent surface (RIS) apparatus 500B that changes a propagation direction of an incident radio wave (radio signal) through reflection or refraction. The “NCR” in the above-described embodiments may be read as the “RIS”.

The RIS is a type of a relay device (hereinafter, also referred to as a “RIS-Fwd”) capable of performing beamforming (directivity control) in the same and/or similar way to the NCR by changing the characteristics of metamaterials. The RIS may be able to change a range (distance) of a beam by controlling a reflection direction and/or a refraction direction of each unit element. For example, the RIS may have a configuration capable of controlling the reflection direction and/or refraction direction of each unit element, and focusing on a near UE (directing a beam) or focusing on a far UE (directing a beam).

The RIS apparatus 500B includes a new UE (hereinafter referred to as “RIS-MT”) 520B that is a control terminal for controlling RIS-Fwd 520B. The RIS-MT 520B controls the RIS-Fwd 520B in cooperation with the gNB 200 by establishing a wireless connection to the gNB 200 and performing wireless communication with the gNB 200. The RIS-Fwd 520B may be a reflective RIS. Such an RIS-Fwd 520B reflects an incident radio wave to change a propagation direction of the radio wave. Here, a reflection angle of the radio wave can be variably set. The RIS-Fwd 520B reflects radio waves incident from the gNB 200 toward the UE 100. The RIS-Fwd 520B may be a transmissive RIS. Such an RIS-Fwd 520B refracts an incident radio wave to change the propagation direction of the radio wave. Here, a refraction angle of the radio wave can be variably set.

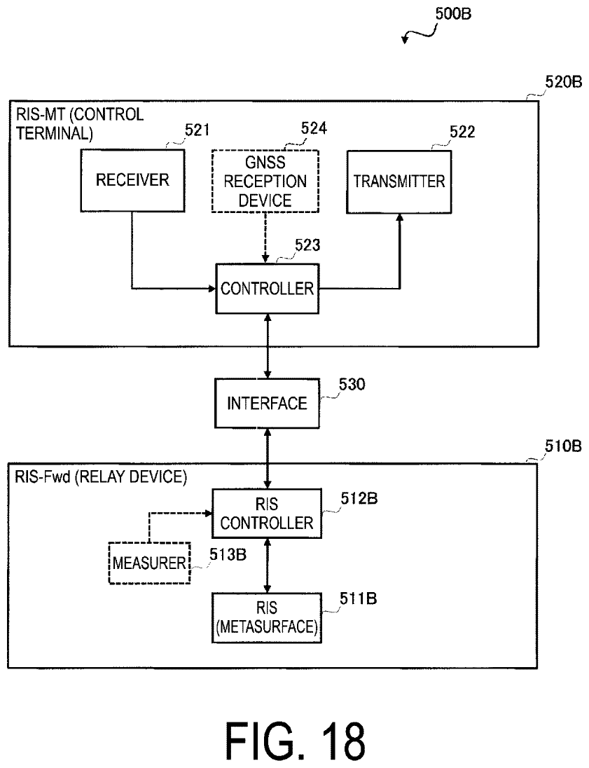

FIG. 18 is a diagram illustrating examples of configurations of the RIS-Fwd (relay device) 510B and the RIS-MT (control terminal) 520B according to the second embodiment. The RIS-MT 520B has a receiver 521, a transmitter 522, and a controller 523. The RIS-MT 520B may include the GNSS reception device 524. The GNSS reception device 524 may be provided to the RIS-MT 520B. Such a configuration is the same as and/or similar to that of the above-described embodiment. The RIS-Fwd 520B includes a RIS 511B and a RIS controller 512B. The RIS 511B is a metasurface configured using a metamaterial. For example, RIS 511B is configured by disposing extremely small structures relative to the wavelength of radio waves in an array, and the direction and/or beam shape of the reflected waves can be arbitrarily designed by making the structures different shapes depending on their disposition location. The RIS 511B may be a transparent dynamic metasurface. The RIS 511B may be configured by stacking a transparent glass substrate on transparent version of a metasurface substrate on which a large number of small structures are regularly disposed, and may be capable of dynamically controlling three patterns of a mode of transmitting an incident radio wave, a mode of transmitting a part of a radio wave and reflecting a part thereof, and a mode of reflecting all radio waves by minutely moving the stacked glass substrate. The RIS controller 512B controls the RIS 511B in response to a RIS control signal from the controller 523 in the RIS-MT 520B. The RIS controller 512B may include at least one processor and at least one actuator. The processor interprets a RIS control signal from the controller 523 in the RIS-MT 520B to drive the actuator in response to the RIS control signal.

The RIS-Fwd 520B may include a measurer 513B. Note that the measurer 513B may be arranged in the RIS-MT 520B. As in the first embodiment, the measurer 513B may measure an uplink (UL) signal from the UE 100 to the RIS-Fwd 520B in the access link. The measurer 513B may measure a DL signal from the gNB 200 to the RIS-Fwd 520B in the backhaul link. For measuring the DL signal from the gNB 200 to the NCR-Fwd 510A, the measurer 513B may be at least partially shared with the receiver 521 of the NCR-MT 520A.

### (3) Other Embodiments

In the above-described embodiment, an example in which the relay apparatus performing relay transmission is the NCR apparatus 500A or a RIS apparatus 500B has been described. However, the relay apparatus that performs relay transmission is not limited to the NCR apparatus 500A or the RIS apparatus 500B, and may be an integrated access and backhaul (IAB) node defined in the technical specifications of 3GPP.

The operation flows described above can be separately and independently implemented, and also be implemented in combination of two or more of the operation flows. For example, some steps of one operation flow may be added to another operation flow or some steps of one operation flow may be replaced with some steps of another operation flow. In each flow, all steps may not be necessarily performed, and only some of the steps may be performed.

In the above-described embodiment, an example in which the base station is an NR base station (gNB) has been described, but the base station may be an LTE base station (eNB). The base station may be a relay node such as an IAB node. The base station may be a distributed unit (DU) of the IAB node. The UE 100 may be a Mobile Termination (MT) of the IAB node.

That is, the UE 100 may be a terminal function unit (a type of communication module) for a base station to control a relay device that performs signal relay. Such terminal function unit is referred to as an MT. Examples of the MT include, a Network Controlled Repeater (NCR)-MT, a Reconfigurable Intelligent Surface (RIS)-MT, in addition to the IAB-MT.

The term “network node” mainly means a base station, but may also mean a core network apparatus or a part (CU, DU, or RU) of the base station. The network node may include a combination of at least a part of the apparatus of the core network and at least a part of the base station.

A program causing a computer to execute each of the processes performed by the communication apparatus according to the embodiments described above, for example, the UE 100 (NCR-MT 520A and RIS-MT 520B), the gNB 200, or the relay apparatus may be provided. The program may be recorded in a computer-readable medium. Use of the computer-readable medium enables the program to be installed on a computer. Here, the computer-readable medium on which the program is recorded may be a non-transitory recording medium. The non-transitory recording medium is not particularly limited, and may be, for example, a recording medium such as a CD-ROM or a DVD-ROM. Circuits for executing each processing performed by the UE 100, the gNB 200, or the relay apparatus may be integrated, and at least a part of the UE 100, the gNB 200, or the relay apparatus may be configured as a semiconductor integrated circuit (chipset or system on a chip (SoC)).

Functions realized by the UE 100, the gNB 200 (network node), or the relay apparatus may be implemented in circuitry or processing circuitry that includes a general-purpose processor, a special-purpose processor, an integrated circuit, an application specific integrated circuit (ASIC), a central processing unit (CPU), conventional circuit, and/or combinations thereof programmed to realize the described functions. The processor includes a transistor and other circuits, and is considered as circuitry or processing circuitry. The processor may be a programmed processor that executes a program stored in a memory. In the present description, circuitry, units, means are hardware programmed to achieve or hardware to execute the described functions. The hardware may be any hardware disclosed in the present description, any hardware programmed to achieve or known to execute the described functions. When the hardware is a processor considered to be a type of circuitry, the circuitry, means, or units are a combination of hardware and software used to configure the hardware and/or processor.

The phrases “based on” and “depending on/in response to” used in the present disclosure do not mean “based only on” and “only depending on/in response to” unless specifically stated otherwise. The phrase “based on” means both “based only on” and “based at least in part on”. The phrase “depending on” means both “only depending on” and “at least partially depending on”. The terms “include”, “comprise” and variations thereof do not mean “include only items stated” but instead mean “may include only items stated” or “may include not only the items stated but also other items”. The term “or” used in the present disclosure is not intended to be “exclusive or”. Any references to elements using designations such as “first” and “second” as used in the present disclosure do not generally limit the quantity or order of those elements. These designations may be used herein as a convenient method of distinguishing between two or more elements. Thus, a reference to first and second elements does not mean that only two elements may be employed there or that the first element needs to precede the second element in some manner. For example, when the English articles such as “a”, “an”, and “the” are added in the present disclosure through translation, these articles include the plural unless clearly indicated otherwise in context.

Embodiments have been described above in detail with reference to the drawings, but specific configurations are not limited to those described above, and various design variation can be made without departing from the gist of the present disclosure.

### (4) Supplementary Notes

Features relating to the embodiments described above are described below as supplements.

### Supplementary Note 1

A communication method performed in a relay apparatus, the relay apparatus including a relay device configured to perform a relay operation of relaying a radio signal transmitted between a network and a user equipment, and a control terminal configured to receive a control signal used for control of the relay device from the network, the method including the steps of:
measuring a radio environment related to the relay apparatus; and
transmitting measurement information obtained by the measuring from the control terminal to the network.

### Supplementary Note 2

The communication method according to supplementary note 1, wherein the measuring step includes a step of measuring a radio environment of an access link between the relay apparatus and the user equipment.

### Supplementary Note 3

The communication method according to supplementary note 2, wherein the step of measuring the radio environment of the access link includes a step of measuring a received power and/or a received quality of an uplink radio signal received by the relay apparatus from the user equipment.

### Supplementary Note 4

The communication method according to supplementary note 2, wherein the step of measuring the radio environment of the access link includes a step of measuring a transmission power of a downlink radio signal transmitted from the relay apparatus to the user equipment.

### Supplementary Note 5

The communication method according to any one of supplementary notes 1 to 4, wherein the measuring step includes a step of measuring a transmission power of an uplink radio signal transmitted from the relay apparatus to the network.

### Supplementary Note 6

The communication method according to any one of supplementary notes 1 to 5, wherein the measuring step includes a step of measuring and holding the radio environment in response to off control being performed to switch the relay device from an on state to an off state.

### Supplementary Note 7

The communication method according to any one of supplementary notes 1 to 6, wherein the measuring step includes a step of measuring a state of a beam formed by a network node included in the network.

### Supplementary Note 8

The communication method according to any one of supplementary notes 1 to 7, wherein the measuring step includes a step of measuring the radio environment when the control terminal is in a radio resource control (RRC) connected state, and the transmitting step includes a step of transmitting the measurement information to the network when the control terminal is in the RRC connected state.

### Supplementary Note 9

The communication method according to any one of supplementary notes 1 to 7, the method further including:
the step of holding the measurement information when the control terminal is in a radio resource control (RRC) idle state or an RRC inactive state,
wherein the transmitting step includes a step of transmitting the held measurement information to the network when the control terminal is in an RRC connected state.

### Supplementary Note 10

The communication method according to any one of supplementary notes 1 to 9, the method further including the step of acquiring location information indicating a location of the relay apparatus at the time of the measuring,
wherein the transmitting step includes a step of transmitting, to the network, the measurement information and the location information associated with the measurement information.

### Supplementary Note 11

A relay apparatus including:
a relay device configured to perform a relay operation of relaying a radio signal transmitted between a network and a user equipment; and
a control terminal configured to receive a control signal used for control of the relay device from the network,
wherein the control terminal is configured to measure a radio environment related to the relay apparatus, and transmit measurement information obtained by the measuring from the control terminal to the network.

### REFERENCE SIGNS

1: Mobile communication system
100: UE
200: gNB
210: Transmitter
220: Receiver
230: Controller
240: Backhaul communicator
300A: AMF
400: OAM server
500A: NCR apparatus
510A: NCR-Fwd
520A: NCR-MT
500B: RIS apparatus
520B: RIS-Fwd
520B: RIS-MT
511A: Wireless unit
511a: Antenna
511b: RF circuit
511c: Directivity controller
511d: Measurer
512A: NCR controller
512B: RIS controller
513B: Measurer
521: Receiver
522: Transmitter
523: Controller
524: GNSS reception device
530: Interface

1. A communication method performed in a relay apparatus,
the relay apparatus comprising:
a relay device configured to perform a relay operation of relaying a radio signal transmitted between a network and a user equipment; and
a control terminal configured to receive a control signal used for control of the relay device from the network,
the method comprising:
measuring a radio environment related to the relay apparatus; and
transmitting measurement information obtained by the measuring from the control terminal to the network.

2. The communication method according to claim 1, wherein
the measuring comprises measuring a radio environment of an access link between the relay apparatus and the user equipment.

3. The communication method according to claim 2, wherein
the measuring of the radio environment of the access link comprises measuring a received power and/or a received quality of an uplink radio signal received by the relay apparatus from the user equipment.

4. The communication method according to claim 2, wherein
the measuring of the radio environment of the access link comprises measuring a transmission power of a downlink radio signal transmitted from the relay apparatus to the user equipment.

5. The communication method according to claim 1, wherein
the measuring comprises measuring a transmission power of an uplink radio signal transmitted from the relay apparatus to the network.

6. The communication method according to claim 1, wherein
the measuring comprises measuring and holding the radio environment in response to off control being performed to switch the relay device from an on state to an off state.

7. The communication method according to claim 1, wherein
the measuring comprises measuring a state of a beam formed by a network node comprised in the network.

8. The communication method according to claim 1, wherein
the measuring comprises measuring the radio environment when the control terminal is in a radio resource control (RRC) connected state, and
the transmitting comprises transmitting the measurement information to the network when the control terminal is in the RRC connected state.

9. The communication method according to claim 1, the method further comprising:
holding the measurement information when the control terminal is in a radio resource control (RRC) idle state or an RRC inactive state,
wherein the transmitting comprises transmitting the held measurement information to the network when the control terminal is in an RRC connected state.

10. The communication method according to claim 1, the method further comprising:
acquiring location information indicating a location of the relay apparatus at the time of the measuring,
wherein the transmitting comprises transmitting, to the network, the measurement information and the location information associated with the measurement information.

11. A relay apparatus comprising:
a relay device configured to perform a relay operation of relaying a radio signal transmitted between a network and a user equipment; and
a control terminal configured to receive a control signal used for control of the relay device from the network,
wherein the control terminal is configured to measure a radio environment related to the relay apparatus, and transmit measurement information obtained by the measuring from the control terminal to the network.
